(19) United States
(12) Patent Application Publication
(10) Pub. No.: US 2026/0352973 A1
(43) Pub. Date: Nov. 5, 2026

(54) PHOTOELECTRIC CONVERSION DEVICE AND PHOTOELECTRIC CONVERSION SYSTEM

(71) Applicant: CANON KABUSHIKI KAISHA, Tokyo (JP)

(72) Inventors: HIROMASA TSUBOI, Tokyo (JP); YUSUKE ONUKI, Kanagawa (JP)

(21) Appl. No.: 19/632,844

(22) Filed: Mar. 30, 2026

(30) Foreign Application Priority Data
Apr. 17, 2025 (JP) 2025-068326

(51) Int. Cl. H04N 25/63; H04N 25/616; H04N 25/67; H04N 25/704; H04N 25/705; H04N 25/778

(52) U.S. Cl. CPC H04N 25/63; H04N 25/616; H04N 25/67; H04N 25/778; H04N 25/704; H04N 25/705

(57) ABSTRACT

A photoelectric conversion device includes first and second photoelectric conversion units generating charge, a first transistor transferring charge of the first photoelectric conversion unit to a first node, a second transistor outputting a signal according to a first node voltage, a third transistor outputting the signal to a first signal line, and a fourth transistor outputting the signal to a second signal line. The first and second photoelectric conversion units are arranged in a first direction. The second transistor is arranged to overlap a first line passing between the first and second photoelectric conversion units and intersecting the first direction. The third, second, fourth transistors are arranged along the first direction. A gate of the third transistor is arranged adjacent to the first photoelectric conversion unit in a second direction. A gate of the fourth transistor is arranged adjacent to the second photoelectric conversion unit in the second direction.

### BACKGROUND

### Field of the Technology

The present disclosure relates to a photoelectric conversion device and a photoelectric conversion system.

### Description of the Related Art

Japanese Patent Laid-Open No. 2018-207291 describes a solid-state imaging device in which some elements of a pixel circuit are shared by a plurality of pixels.

However, in the solid-state imaging device described in Japanese Patent Laid-Open No. 2018-207291, noise generated due to driving of transistors constituting the pixel circuit is not necessarily sufficiently considered, and there is a possibility that a noise component superimposed on an output signal is not sufficiently suppressed.

### SUMMARY

The present disclosure is directed to provide a technique for reducing the influence of noise generated due to driving of transistors constituting a pixel circuit in a photoelectric conversion device including a plurality of photoelectric conversion units.

According to an embodiment of the present specification, there is provided a photoelectric conversion device including a first photoelectric conversion unit and a second photoelectric conversion unit each configured to generate charge according to incidence of light, a first transistor configured to transfer charge held by the first photoelectric conversion unit to a first node, a second transistor configured to output a signal according to a voltage of the first node, a third transistor configured to output an output signal of the second transistor to a first signal line, and a fourth transistor configured to output the output signal of the second transistor to a second signal line, wherein the first photoelectric conversion unit and the second photoelectric conversion unit are arranged in a first direction in a plan view, wherein the second transistor is arranged to overlap a first straight line that passes between the first photoelectric conversion unit and the second photoelectric conversion unit and intersects the first direction in the plan view, wherein the third transistor, the second transistor, and the fourth transistor are arranged in this order along the first direction, wherein a gate electrode of the third transistor is arranged adjacent to the first photoelectric conversion unit in a second direction intersecting the first direction, and wherein a gate electrode of the fourth transistor is arranged adjacent to the second photoelectric conversion unit in the second direction.

Also, according to another aspect of the present specification, there is provided a photoelectric conversion device including an insulator isolation portion configured to define a plurality of active regions in a first face of a semiconductor layer, a first photoelectric conversion unit arranged in a first active region of the plurality of active regions and configured to generate charge according to incidence of light, a second photoelectric conversion unit arranged in a second active region of the plurality of active regions and configured to generate charge according to incidence of light, a first transistor arranged in the first active region and configured to transfer charge of the first photoelectric conversion unit to a first node, a second transistor arranged in a third active region and configured to output a signal according to a voltage of the first node, a third transistor arranged in a fourth active region and configured to output an output signal of the second transistor to a first signal line, and a fourth transistor arranged in a fifth active region and configured to output the output signal of the second transistor to a second signal line, wherein the first photoelectric conversion unit and the second photoelectric conversion unit are arranged in a first direction in a plan view, wherein the second transistor is arranged to overlap a first straight line that passes between the first photoelectric conversion unit and the second photoelectric conversion unit and intersects the first direction in the plan view, wherein the third transistor, the second transistor, and the fourth transistor are arranged in this order along the first direction, wherein a gate electrode of the third transistor is arranged adjacent to the first photoelectric conversion unit in a second direction intersecting the first direction, and wherein a gate electrode of the fourth transistor is arranged adjacent to the second photoelectric conversion unit in the second direction.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a schematic configuration of a photoelectric conversion device according to a first embodiment.

FIG. 2 is a schematic diagram illustrating a configuration example of the photoelectric conversion device according to the first embodiment.

FIG. 3 is an equivalent circuit diagram illustrating a configuration example of a pixel of the photoelectric conversion device according to the first embodiment.

FIG. 4 is a plan view illustrating a structure of the pixel of the photoelectric conversion device according to the first embodiment.

FIG. 5 is a schematic cross-sectional view illustrating a structure of the pixel of the photoelectric conversion device according to the first embodiment.

FIG. 6 is an equivalent circuit diagram illustrating a configuration example of a pixel of a photoelectric conversion device according to a second embodiment.

FIG. 7 is a plan view illustrating a structure of a pixel of the photoelectric conversion device according to the second embodiment.

FIG. 8 is a plan view illustrating a structure of a pixel of a photoelectric conversion device according to a third embodiment.

FIG. 9 is a plan view illustrating a structure of a pixel of a photoelectric conversion device according to a fourth embodiment.

FIG. 10 is an equivalent circuit diagram illustrating a configuration example of a pixel of a photoelectric conversion device according to a fifth embodiment.

FIG. 11 is a plan view illustrating a structure of the pixel of the photoelectric conversion device according to the fifth embodiment.

FIG. 12 is an equivalent circuit diagram illustrating a configuration example of a pixel of a photoelectric conversion device according to a sixth embodiment.

FIG. 13 is a plan view illustrating a structure of the pixel of the photoelectric conversion device according to the sixth embodiment.

FIG. 14 is a schematic cross-sectional view illustrating a structure of the pixel of the photoelectric conversion device according to the sixth embodiment.

FIG. 15 is an equivalent circuit diagram illustrating a configuration example of a pixel of a photoelectric conversion device according to a seventh embodiment.

FIG. 16 is a plan view illustrating a structure of the pixel of the photoelectric conversion device according to the seventh embodiment.

FIG. 17 is a block diagram illustrating a schematic configuration of a photoelectric conversion system according to an eighth embodiment.

FIG. 18A is a diagram illustrating a configuration example of a photoelectric conversion system according to a ninth embodiment.

FIG. 18B is a diagram illustrating a configuration example of a movable object according to the ninth embodiment.

FIG. 19 is a block diagram illustrating a schematic configuration of an equipment according to a tenth embodiment.

### DESCRIPTION OF THE EMBODIMENTS

Hereinafter, embodiments of the present disclosure will be described in detail with reference to the accompanying drawings. The following embodiments are intended to embody the technical idea of the present disclosure and do not limit the technology of the present disclosure. Although a plurality of features is described in the embodiments, not all of the plurality of features are essential to the technology of the present disclosure, and the plurality of features may be arbitrarily combined.

In each of the embodiments described below, devices for imaging purposes will be mainly described as an example of a photoelectric conversion device. However, the embodiments are not limited to the devices for imaging purposes and may be applied to other photoelectric conversion devices. For example, other examples of the photoelectric conversion device include a ranging device (a device for distance measurement and the like using a focus detection or a time of flight (TOF)), a photometric device (a device for measuring the amount of incident light), and the like.

In the following embodiments, connection between elements of a circuit may be described. In this case, even when another element is interposed between the elements of interest, the elements of interest are treated as being connected to each other unless otherwise specified. For example, it is assumed that an element A is connected to one node of a capacitor C having a plurality of nodes, and an element B is connected to the other node of the capacitor. Even in such a case, the element A and the element B are regarded as being connected to each other unless otherwise specified.

In the following description, a term indicating a specific direction or position (for example, “up”, “down”, “right”, “left” and other terms including those terms) is used as necessary. The use of these terms is to facilitate understanding of the embodiments with reference to the drawings, and the technical scope of the present disclosure is not limited by the meanings of these terms. In addition, sizes and positional relationships of members illustrated in the drawings may be exaggerated for clarity of description.

### FIRST EMBODIMENT

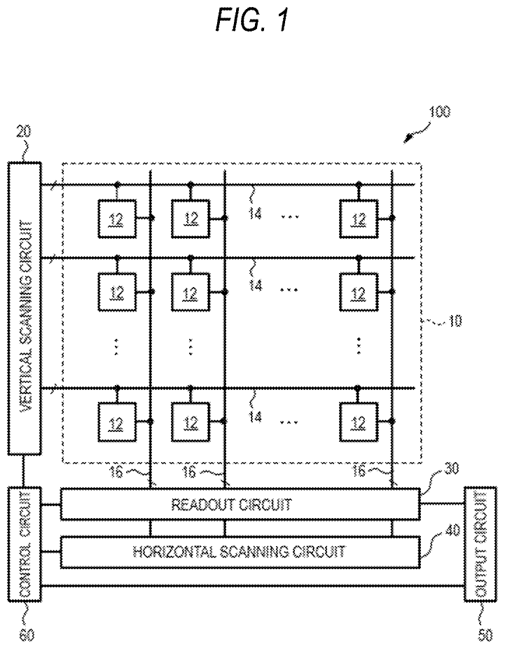

A schematic configuration of a photoelectric conversion device according to a first embodiment will be described with reference to FIG. 1. FIG. 1 is a block diagram illustrating a schematic configuration of a photoelectric conversion device according to the present embodiment.

As illustrated in FIG. 1, the photoelectric conversion device 100 according to the present embodiment includes a pixel array unit 10, a vertical scanning circuit 20, a readout circuit 30, a horizontal scanning circuit 40, an output circuit 50, and a control circuit 60. The pixel array unit 10 is connected to the vertical scanning circuit 20 and the readout circuit 30. The readout circuit 30 is connected to the horizontal scanning circuit 40 and the output circuit 50. The control circuit 60 is connected to the vertical scanning circuit 20, the readout circuit 30, the horizontal scanning circuit 40, and the output circuit 50.

The pixel array unit 10 is provided with a plurality of pixels 12 arranged in a matrix so as to form a plurality of rows and a plurality of columns. Each pixel 12 includes a photoelectric conversion unit including a photoelectric conversion element such as a photodiode and outputs a pixel signal according to the amount of incident light. The number of rows and the number of columns of the pixel array arranged in the pixel array unit 10 are not particularly limited. In addition to effective pixels that output pixel signals according to the amount of incident light, the pixel array unit 10 may include optical black pixels in which photoelectric conversion units are shielded from light, dummy pixels that do not output signals, and the like.

Each row of the pixel array unit 10 is provided with a control line 14 extending in a first direction (lateral direction in FIG. 1). Each of the control lines 14 is connected to the pixels 12 arranged in the first direction in the corresponding row and forms a signal line common to these pixels 12. The first direction in which the control lines 14 extend may be referred to as a row direction or a horizontal direction. Each of the control lines 14 may be constituted by a plurality of signal lines for supplying a plurality of types of control signals to the pixels 12 in the corresponding row. Each of the control lines 14 is connected to the vertical scanning circuit 20.

Each column of the pixel array unit 10 is provided with an output line 16 extending in a second direction (vertical direction in FIG. 1) intersecting the first direction. Each of the output lines 16 is connected to the pixels 12 arranged in the second direction in the corresponding column and forms a signal line common to these pixels 12. The second direction in which the output lines 16 extend may be referred to as a column direction or a vertical direction. Each of the output lines 16 includes a plurality of signal lines. Hereinafter, a case where the output line 16 of each column has two signal lines 16A and 16B will be described, but the number of signal lines constituting each of the output lines 16 may be three or more. Each of the output lines 16 is connected to the readout circuit 30.

The vertical scanning circuit 20 has a function of generating a control signal for driving the pixels 12 in accordance with a control signal from the control circuit 60. The vertical scanning circuit 20 sequentially supplies the generated control signals to the control lines 14 of the respective rows, thereby performing an operation of driving the plurality of pixels 12 arranged in the pixel array unit 10 in units of rows, that is, so-called vertical scanning. The vertical scanning circuit 20 may be configured using a shift register or an address decoder. Signals read out from the pixels 12 in units of rows by vertical scanning are input to the readout circuit 30 via the output lines 16 of the respective columns.

The readout circuit 30 includes a plurality of column circuits corresponding to each column of the pixel array unit 10 and may have a function of performing predetermined signal processing on the pixel signals output from the pixel array unit 10. Examples of the signal processing on the pixel signal include amplification processing, noise removal processing, addition processing, and A/D (analog-to-digital) conversion processing. The readout circuit 30 may include a column amplifier, a correlation double sampling (CDS) circuit, an addition circuit, an A/D conversion circuit, and the like. The readout circuit 30 may include a signal holding unit for holding the pixel signals of the respective columns received from the pixel array unit 10 or the pixel signals of the respective columns after the signal processing.

The horizontal scanning circuit 40 has a function of generating a control signal for transferring the pixel signals held by the readout circuit 30 to the output circuit 50 in response to a control signal from the control circuit 60. The horizontal scanning circuit 40 sequentially supplies the generated control signals to the signal holding units of the respective columns of the readout circuit 30 to sequentially transfer the pixel signals held by the signal holding units of the respective columns to the output circuit 50, that is, performs so-called horizontal scanning. The horizontal scanning circuit 40 may be configured using a shift register or an address decoder.

The output circuit 50 may include a signal processing circuit that performs predetermined signal processing on the pixel signals sequentially transferred from the readout circuit 30, and an external interface circuit that outputs the processed pixel signals to the outside of the photoelectric conversion device 100. Examples of the signal processing circuit that may be included in the output circuit 50 include a buffer amplifier and a differential amplifier. Examples of the signal processing performed by the output circuit 50 include correction processing by CDS, amplification processing, and high dynamic range (HDR) composition processing. The external interface circuit included in the output circuit 50 is not particularly limited. A serializer/deserializer (SerDes) transmission circuit may be applicable to the external interface circuit. Examples of the SerDes transmission circuit include a low voltage differential signaling (LVDS) circuit and a scalable low voltage signaling (SLVS) circuit.

The control circuit 60 has a function of supplying control signals for controlling operations and timings thereof of the vertical scanning circuit 20, the readout circuit 30, the horizontal scanning circuit 40, and the output circuit 50 to these functional blocks. Some or all of the control signals supplied to the functional blocks may be supplied from the outside of the photoelectric conversion device 100.

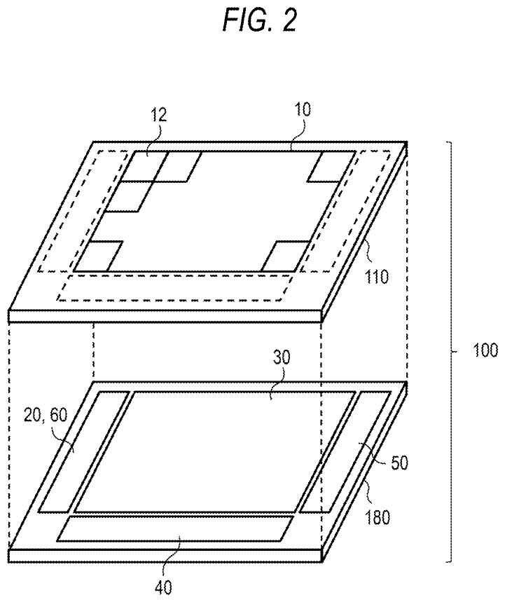

The photoelectric conversion device 100 of the present embodiment may have a configuration in which all the functional blocks described above are arranged on one substrate or may have a configuration in which functional blocks are separately formed on each substrate as a stacked type in which a plurality of substrates is stacked. In the latter case, for example, as illustrated in FIG. 2, the photoelectric conversion device may be configured as a stacked-type photoelectric conversion device in which the pixel substrate 110 and the circuit substrate 180 are stacked and electrically connected to each other.

In the configuration example of FIG. 2, the pixel array unit 10 is arranged on the pixel substrate 110, and other functional blocks are arranged on the circuit substrate 180. By arranging the pixel array unit 10 and the other functional blocks on different substrates, it is possible to reduce the size and increase the functionality of the photoelectric conversion device 100 without sacrificing the area of the pixel array unit 10. The circuit elements constituting one functional block are not necessarily arranged on the same substrate and may be arranged on different substrates.

In the configuration example of FIG. 2, the vertical scanning circuit 20, the horizontal scanning circuit 40, the output circuit 50, and the control circuit 60 are arranged around the pixel array unit 10 so as not to overlap the pixel array unit 10 in a plan view. However, at least a part of the vertical scanning circuit 20, the readout circuit 30, the horizontal scanning circuit 40, the output circuit 50, and the control circuit 60 may overlap the pixel array unit 10 in the plan view. Each of the pixel array unit 10, the vertical scanning circuit 20, the readout circuit 30, the horizontal scanning circuit 40, the output circuit 50, and the control circuit 60 is not necessarily provided on one substrate and may be provided across a plurality of substrates. In this specification, the plan view refers to a plane parallel to a light incident surface of a substrate including a photoelectric conversion unit, as viewed from a normal direction of the plane.

In FIG. 2, a diced chip is assumed as the pixel substrate 110 and the circuit substrate 180, but the pixel substrate 110 and the circuit substrate 180 are not limited to chips. For example, each of the pixel substrate 110 and the circuit substrate 180 may be a wafer. In addition, the pixel substrate 110 and the circuit substrate 180 may be stacked in a wafer state and then diced or may be stacked and bonded after being formed into chips. The number of substrates constituting the stacked-type photoelectric conversion device is not necessarily two and may be three or more.

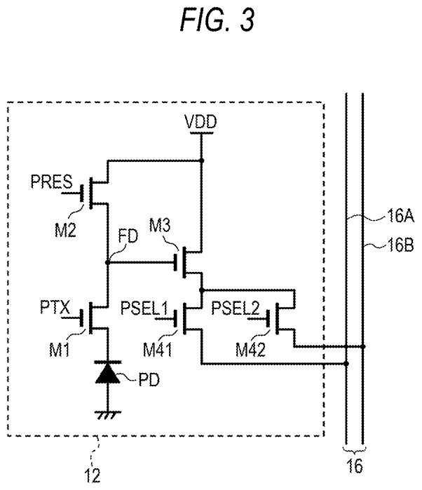

Next, a configuration example of the pixel 12 in the photoelectric conversion device according to the present embodiment will be described with reference to FIG. 3. FIG. 3 is an equivalent circuit diagram illustrating a configuration example of the pixel in the photoelectric conversion device according to the present embodiment.

Each of the pixels 12 included in the pixel array unit 10 may include a photoelectric conversion unit PD, a transfer transistor M1, a reset transistor M2, an amplifier transistor M3, and select transistors M41 and M42 as illustrated in, e.g., FIG. 3. The photoelectric conversion unit PD may be constituted by a photoelectric conversion element, for example, photodiodes. The transfer transistor M1, the reset transistor M2, the amplifier transistor M3, and the select transistors M41 and M42 may be metal-oxide-semiconductor (MOS) transistors. The pixel 12 may include a microlens and a color filter arranged on an optical path until incident light is guided to the photoelectric conversion unit PD. The microlens has a function of collecting incident light on the photoelectric conversion unit PD. The color filter has a function of selectively transmitting light of a predetermined color.

The photoelectric conversion unit PD includes an anode connected to a ground voltage node and a cathode connected to a source of the transfer transistor M1. A drain of the transfer transistor M1 is connected to a source of the reset transistor M2 and a gate of the amplifier transistor M3. A node FD to which the drain of the transfer transistor M1, the source of the reset transistor M2, and the gate of the amplifier transistor M3 are connected is a so-called floating diffusion. The floating diffusion includes a capacitance component (floating diffusion capacitance) and has a function as a charge holding portion.

A drain of the reset transistor M2 and a drain of the amplifier transistor M3 are connected to a power supply voltage node (voltage VDD). A source of the amplifier transistor M3 is connected to a drain of the select transistor M41 and a drain of the select transistor M42. A source of the select transistor M41 is connected to a signal line 16A among the plurality of signal lines constituting the output line 16. A source of the select transistor M42 is connected to a signal line 16B among the plurality of signal lines constituting the output line 16. The voltage supplied to the drain of the reset transistor M2 and the voltage supplied to the drain of the amplifier transistor M3 may be the same or different.

Each of the control lines 14 includes four signal lines including a signal line connected to a gate of the transfer transistor M1, a signal line connected to a gate of the reset transistor M2, a signal line connected to a gate of the select transistor M41, and a signal line connected to a gate of the select transistor M42. A control signal PTX is supplied from the vertical scanning circuit 20 to the signal line connected to the gate of the transfer transistor M1. A control signal PRES is supplied from the vertical scanning circuit 20 to the signal line connected to the gate of the reset transistor M2. A control signal PSEL1 is supplied from the vertical scanning circuit 20 to the signal line connected to the gate of the select transistor M41. A control signal PSEL2 is supplied from the vertical scanning circuit 20 to the signal line connected to the gate of the select transistor M42. In the case where each transistor is formed of an n-channel transistor, the corresponding transistor is turned on when a high-level control signal is supplied from the vertical scanning circuit 20, and the corresponding transistor is turned off when a low-level control signal is supplied from the vertical scanning circuit 20.

The present embodiment will be described on the assumption that electrons among electron-hole pairs generated in the photoelectric conversion unit PD by light incidence are used as signal carriers. When electrons are used as the signal carriers, the transistors constituting the pixel 12 may be n-channel MOS transistors. However, the signal carriers are not limited to electrons, and holes may be used as the signal carriers. When holes are used as signal carriers, the conductivity type of each transistor may be opposite to that described in the present embodiment.

Hereinafter, semiconductor regions of the first conductivity type having the same carriers as the signal carriers as the majority carriers is an n-type semiconductor region, and the semiconductor region of the second conductivity type is a p-type semiconductor region. That is, the signal carriers are electrons. The anode and the cathode of the photoelectric conversion unit are of the n-type and the p-type, respectively. Note that the polarity and the conductivity type may all be reversed. That is, the signal carriers may be holes, the semiconductor region of the first conductivity type may be a p-type semiconductor region, and the semiconductor region of the second conductivity type may be an n-type semiconductor region. The anode and the cathode of the photoelectric conversion unit may be p-type and n-type, respectively. In this case, the voltage relationship is also reversed.

The names of the source and the drain of the MOS transistor may vary depending on the conductivity type of the transistor and the function of interest. Some or all of the names of the source and the drain used in the present embodiment may be referred to as reverse names. In this specification, the source and the drain of each terminal of the MOS transistor may be referred to as a main node, and the gate thereof may be referred to as a control node.

The photoelectric conversion unit PD converts (photoelectrically converts) the incident light into charge of an amount corresponding to the amount of the incident light and accumulate the generated charge. The transfer transistor M1 transfers the charge held by the photoelectric conversion unit PDA to the node FD by turning on in response to the control signal PTX. The node FD holds the charge transferred from the photoelectric conversion unit PD and sets the voltage thereof to a voltage corresponding to the capacitance value of the capacitor coupled thereto (floating diffusion capacitance) and the amount of the transferred charge.

The reset transistor M2 resets the node FD to a voltage corresponding to the voltage VDD by turning on in response to the control signal PRES. At this time, it is also possible to reset the photoelectric conversion unit PD to a voltage corresponding to the voltage VDD by turning on the transfer transistor M1. The timing at which the reset transistor M2 is turned off from the on-state in response to the control signal PRES may be the timing of the start of the exposure period of the photoelectric conversion unit PD. After the charge is transferred from the photoelectric conversion unit PD to the node FD, the timing at which the transfer transistor M1 is turned off from the on-state in response to the control signal PTX may be the timing at which the exposure period of the photoelectric conversion unit PD ends.

The amplifier transistor M3 has the drain to which the voltage VDD is supplied and the source to which a bias current is supplied from a current source (not illustrated) via the select transistors M41, M42 and the output line 16 and constitutes an amplifier unit (source follower circuit) having the gate as an input node. The select transistor M41 connects the amplifier transistor M3 to the signal output line 16A by turning on in response to the control signal PSEL1, so that the output of the signal from the amplifier transistor M3 to the output line 16A is enabled (selected state). Accordingly, the amplifier transistor M3 may output the pixel signal corresponding to the voltage of the node FD to the output line 16A via the select transistor M41. In addition, the select transistor M42 connects the amplifier transistor M3 to the signal output line 16B by turning on in response to the control signal PSEL2, so that the output of the signal from the amplifier transistor M3 to the output line 16B is enabled (selected state). Accordingly, the amplifier transistor M3 may output the pixel signal corresponding to the voltage of the node FD to the output line 16B via the select transistor M42. That is, the amplifier transistor M3 and the select transistors M41 and M42 function as an output unit that outputs a signal according to the voltage of the node FD.

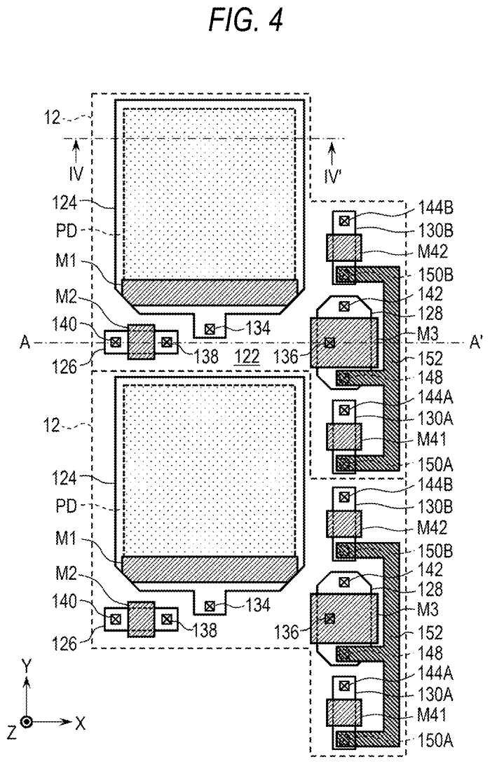

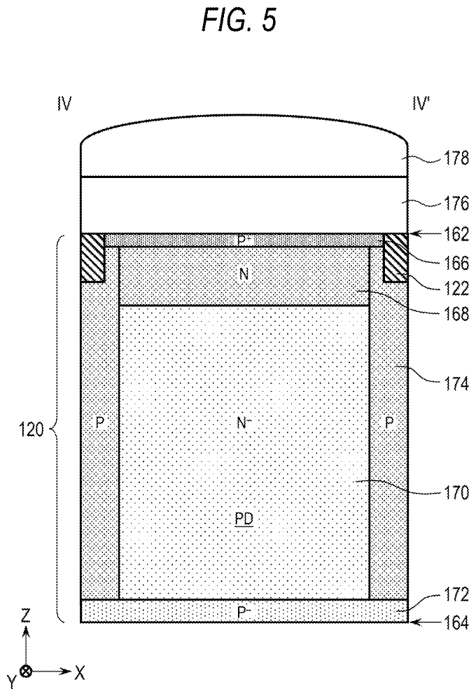

Next, the structure of the pixel 12 in the photoelectric conversion device according to the present embodiment will be described more specifically with reference to FIG. 4 and FIG. 5 by taking a front-illuminated photoelectric conversion device as an example. Here, an example in which the configuration of the present embodiment is applied to a front illuminated photoelectric conversion device will be described, but the configuration may also be applied to a back-illuminated photoelectric conversion device. Note that the front-illuminated photoelectric conversion device is a photoelectric conversion device configured to detect light incident from the front face side of a semiconductor layer (semiconductor substrate) in which transistors, interconnections, and the like are arranged. The back-illuminated photoelectric conversion device is a photoelectric conversion device configured to detect light incident from the back face side of a semiconductor layer (semiconductor substrate) opposite to a face on which transistors, interconnections, and the like are arranged.

FIG. 4 is a plan view of a semiconductor layer (semiconductor substrate) provided with elements constituting the pixel circuit as viewed from a front face side. FIG. 4 illustrates two pixels 12 arranged in the Y direction among the plurality of pixels 12 constituting the pixel array unit 10. In order to simplify the drawings, FIG. 4 illustrates only active regions provided in a semiconductor layer, a polycrystalline silicon layer constituting the gate electrodes of the transistors, and a pattern of a part of interconnections arranged in an upper-level layer than the polycrystalline silicon layer. In FIG. 4, the active regions are represented by a white region surrounded by a solid line. The polycrystalline silicon layer is represented by a region surrounded by a solid line and having a diagonal line pattern slanting downward to the left, and the gate electrode of each transistor is denoted by a reference numeral representing the transistor. The interconnection is represented by a region surrounded by a solid line and having a diagonal line pattern slanting downward to the right. In addition, rectangular regions with x-marked indicate a contact plug or a via plug between layers for connecting conductive members. The pixel array unit 10 is configured by repeatedly arranging the unit structures illustrated in FIG. 4 in translational symmetry with respect to the X direction and the Y direction. The X direction may be parallel to the first direction (row direction or horizontal direction), and the Y direction may be parallel to the second direction (column direction or vertical direction).

An insulator isolation portion 122 defining active regions 124, 126, 128, 130A and 130B of each pixel 12 is provided in the front face (first face) side of a semiconductor layer 120. The insulator isolation portion 122 may be formed by a shallow trench isolation (STI) method, a local oxidation of silicon (LOCOS) method, or the like. The photoelectric conversion unit PD and the transfer transistor M1 are provided in the active region 124. In the active region 126, 128, 130A and 130B, the reset transistor M2, the amplifier transistor M3, the select transistor M41, and the select transistor M42 are provided, respectively.

A gate electrode of the transfer transistor M1 is provided over the active region 124. The gate electrode of the transfer transistor M1 extends in the X direction. In FIG. 4, a region above the gate electrode of the transfer transistor M1 is a source region of the transfer transistor M1 including the cathode of the photoelectric conversion unit PD, and a region below the gate electrode of the transfer transistor M1 is a drain region of the transfer transistor M1. End portions on the gate width direction of the gate electrode of the transfer transistor M1 may be located over the insulator isolation portion 122 or may be located over the active region 124.

The active region 126 is arranged between the active regions 124 of the two pixels 12 adjacent to each other in the Y direction. Assuming an imaginary straight line A-A′ passing between the active regions 124 of the two pixels 12 adjacent to each other in the Y direction and extending in the X direction, the active region 126 is located on the straight line A-A′. The active region 126 has a rectangular shape elongated in the X direction, and the reset transistor M2 is provided in the active region 126 so that the gate length direction thereof is parallel to the X direction.

Like the active region 126, the active region 128 is located on the straight line A-A′. The active region 128 is located between the active region 130A and the active region 130B in the Y direction. That is, the active region 130A, the active region 128, and the active region 130B are arranged in this order in the Y direction. The active region 128 has a shape elongated in the Y direction, and the amplifier transistor M3 is provided in the active region 128 so that the gate length direction thereof is parallel to the Y direction. However, the active region 128 may have a shape elongated in the X direction, and the amplifier transistor M3 may be provided in the active region 128 so that the gate length direction thereof is parallel to the X direction. The gate width of the amplifier transistor M3 is preferably larger than the gate widths of the reset transistor M2 and the select transistors M41 and M42 from the viewpoint of improving the current drive capability. The active regions 130A and 130B have a shape elongated in the Y direction, and the select transistors M41 and M42 are provided in the active regions 130A and 130B so that the gate length direction thereof is parallel to the Y direction.

The gate electrode of the select transistor M42 is arranged adjacent to the active region 124 of one pixel 12 (the upper pixel 12 in FIG. 4) in the X direction. The gate electrode of the select transistor M41 is arranged adjacent to the active region 124 of another pixel 12 (the lower pixel 12 in FIG. 4), that is adjacent to the one pixel 12 in the column direction, in the X direction. In other words, the gate electrodes of the two select transistors M41 and M42 included in one pixel 12 face the photoelectric conversion units PD of the pixels 12 different from each other.

The drain of the transfer transistor M1 is electrically connected to an interconnection (not illustrated) via a contact plug 134. The source of the reset transistor M2 is electrically connected to the interconnection (not illustrated) via the contact plug 138. The gate electrode of the amplifier transistor M3 is electrically connected to the interconnection (not illustrated) via the via plug 136. Thus, the drain of the transfer transistor M1, the source of the reset transistor M2, and the gate electrode of the amplifier transistor M3 are electrically connected to each other via the interconnection (not illustrated). This node including the drain of the transfer transistor M1, the source of the reset transistor M2, the gate of the amplifier transistor M3, and the interconnection (not illustrated) is the node FD.

The source of the amplifier transistor M3 is connected to an interconnection 152 via the contact plug 148. The drain of the select transistor M41 is connected to the interconnection 152 via the contact plug 150A. The drain of the select transistor M42 is connected to the interconnection 152 via the contact plug 150B. Thus, the source of the amplifier transistor M3, the drain of the select transistor M41, and the drain of the select transistor M42 are electrically connected to each other via the interconnection 152.

The drain of the reset transistor M2 is supplied with the voltage VDD via an interconnection (not illustrated) and the contact plug 140. The drain of the amplifier transistor M3 is supplied with the voltage VDD via an interconnection (not illustrated) and the contact plug 142. The source of the select transistor M41 is connected to the signal line 16A via the contact plug 144A. The source of the select transistor M42 is connected to the signal line 16B via the contact plug 144B.

In a case where the gate electrode of the amplifier transistor and the gate electrode of the select transistor face the photoelectric conversion unit, the dark current flowing into the photoelectric conversion unit may increase by turning on these transistors. Specifically, the electric field from the gate electrode of the amplifier transistor or the select transistor set to high-level may decrease the hole density at the interface with the insulator isolation portion, and the dark current may increase. If the dark current flows into the photoelectric conversion unit, a noise component superimposed on the signal charge may increase. Further, since the size of the gate electrode of the amplifier transistor is generally larger than the size of the gate electrode of the select transistor, the influence of the electric field from the gate electrode of the amplifier transistor is large.

In the present embodiment, the gate electrodes of the select transistors M41 and M42 are arranged so as to face the photoelectric conversion unit PD. Therefore, when the select transistors M41 and M42 are turned on, the electric field from the gate electrodes of the select transistors M41 and M42 set to high-level may decrease the hole density at the interface with the insulator isolation portion 122 and increase the dark current. However, in the present embodiment, since the gate electrodes of the select transistors M41 and M42 are arranged so as to face the photoelectric conversion units PD of the other pixels 12, the amount of dark current flowing into each photoelectric conversion unit PD during the operation of the select transistors M41 and M42 may be made equal. Accordingly, it is possible to reduce stripe-shaped fixed pattern noise superimposed on the captured image in accordance with the driving of the select transistors M41 and M42.

FIG. 5 is a schematic cross-sectional view illustrating the structure of the photoelectric conversion unit PD and corresponds to a cross-sectional view taken along line IV-IV′ of FIG. 4.

The semiconductor layer 120 provided with the photoelectric conversion unit PD has a first face 162 on the front face side and a second face 164 on the back face side. The semiconductor layer 120 includes p-type semiconductor regions 166, 172, and 174, n-type semiconductor regions 168 and 170, and an insulator isolation portion 122.

The n-type semiconductor regions 168 and 170 function as a cathode of the photodiode included in the photoelectric conversion unit PD. The n-type semiconductor region 168 is arranged on a side of the first face 162 of the semiconductor layer 120, and the n-type semiconductor region 170 is arranged on a side of the second face 164 of the semiconductor layer 120. The n-type semiconductor region 170 serves as a photoelectric conversion region, and the n-type semiconductor region 168 serves to collect signal charge generated in the n-type semiconductor region 170. For these purposes, the peak impurity concentration of the n-type semiconductor region 168 is set higher than the peak impurity concentration of the n-type semiconductor region 170. A p-type semiconductor region 174 is provided on side faces of the n-type semiconductor regions 168 and 170. The p-type semiconductor region 174 has a function as the anode of a photodiode constituting the photoelectric conversion unit PD and also has a function of isolating adjacent photoelectric conversion units PD from each other.

The p-type semiconductor region 166 is provided in contact with the first face 162 of the semiconductor layer 120. The p-type semiconductor region 172 is provided in contact with the second face 164 of the semiconductor layer 120. The p-type semiconductor regions 166 and 172 have a function of suppressing a dark current generated on the first face 162 and the second face 164, respectively. The peak impurity concentration of the p-type semiconductor region 166 is set higher than the peak impurity concentration of the p-type semiconductor region 172. The insulator isolation portion 122 is provided in the surface portion of the first face 162 of the semiconductor layer 120 and has a function of isolating the transistors and the photoelectric conversion units PD from each other. The insulator isolation portion 122 is surrounded by the p-type semiconductor regions 166 and 174.

Over the first face 162 of the semiconductor layer 120, an interconnection structure layer 176 including the gate layer constituting the gate electrodes of the transistors and metal interconnection layers is provided. An optical structure layer 178 including the color filter, the microlens, and the like is provided over the interconnection structure layer 176. A circuit substrate 180 or a support substrate (not illustrated) may be bonded to the second face 164 of the semiconductor layer 120.

As described above, in the present embodiment, two select transistors M41 and M42 are provided in one pixel 12, and a pixel signal may be output to a different signal line for each row. Accordingly, the signals of the pixels 12 in a plurality of rows may be simultaneously output, and the imaging speed may be increased. In addition, in the present embodiment, the gate electrodes of the select transistors M41 and M42 are arranged so as to face the photoelectric conversion unit PD of another pixel 12. With such an arrangement, it is possible to reduce stripe-shaped fixed pattern noise superimposed on the captured image according to the driving of the select transistors M41 and M42.

As described above, according to the present embodiment, in a photoelectric conversion device including a plurality of photoelectric conversion units, it is possible to reduce the influence of noise generated due to driving of transistors constituting a pixel circuit.

### SECOND EMBODIMENT

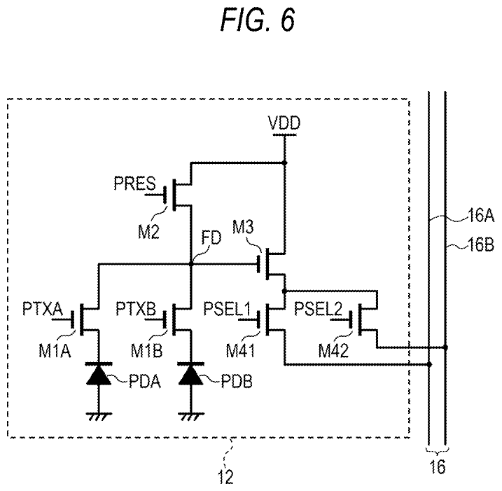

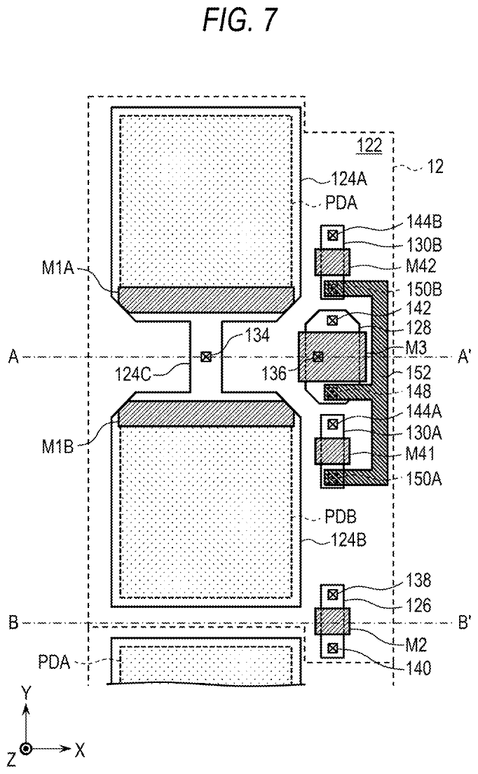

A photoelectric conversion device according to a second embodiment will be described with reference to FIG. 6 and FIG. 7. The same components as those of the photoelectric conversion device according to the first embodiment are denoted by the same reference numerals, and description thereof will be omitted or simplified.

The photoelectric conversion device according to the present embodiment is the same as the photoelectric conversion device according to the first embodiment except that the configuration of the pixel 12 is different. In the present embodiment, differences from the photoelectric conversion device according to the first embodiment will be mainly described, and description of points similar to those of the photoelectric conversion device according to the first embodiment will be appropriately omitted.

The pixel 12 of the present embodiment is different from the pixel 12 of the photoelectric conversion device according to the first embodiment in that it includes two photoelectric conversion units PDA and PDB and two transfer transistors M1A and M1B. That is, as illustrated in FIG. 6, the pixel 12 of the present embodiment includes photoelectric conversion units PDA and PDB, transfer transistors M1A and M1B, a reset transistor M2, an amplifier transistor M3, and select transistors M41 and M42. The photoelectric conversion units PDA and PDB may have separate microlenses corresponding to the photoelectric conversion units PDA and PDB, respectively, or may share one microlens.

The photoelectric conversion units PDA and PDB may be constituted by photoelectric conversion elements, for example, photodiodes. The photoelectric conversion unit PDA has an anode connected to the ground voltage node and a cathode connected to a source of the transfer transistor M1A. The photoelectric conversion unit PDB has an anode connected to the ground voltage node and a cathode connected to a source of the transfer transistor M1B. Drains of the transfer transistors M1A and M1B are connected to the source of the reset transistor M2 and the gate of the amplifier transistor M3. The connection relationship of the other elements is the same as that of the pixel of the first embodiment.

Each of the control lines 14 includes five signal lines connected to the gates of the transfer transistors M1A and M1B, the reset transistor M2, and the select transistors M41 and M42. A control signal PTXA is supplied from the vertical scanning circuit 20 to the signal line connected to a gate of the transfer transistor M1A. A control signal PTXB is supplied from the vertical scanning circuit 20 to the signal line connected to a gate of the transfer transistor M1B. In the case where each transistor is formed of an n-channel transistor, the corresponding transistor is turned on when a high-level control signal is supplied from the vertical scanning circuit 20, and the corresponding transistor is turned off when a low-level control signal is supplied from the vertical scanning circuit 20.

It is also considered that the pixel circuit of FIG. 6 includes a pixel 12 including the photoelectric conversion unit PDA and the transfer transistor M1A and the pixel 12 including the photoelectric conversion unit PDB and the transfer transistor M1B. In this case, the pixel 12 including the photoelectric conversion unit PDA and the transfer transistor M1A and the pixel 12 including the photoelectric conversion unit PDB and the transfer transistor M1B share the node FD, the reset transistor M2, the amplifier transistor M3, and the select transistors M41 and M42. For example, the pixel 12 including the photoelectric conversion unit PDA and the transfer transistor M1A and the pixel 12 including the photoelectric conversion unit PDB and the transfer transistor M1B may be two pixels 12 arranged in adjacent rows of the same column. By applying such a configuration, the number of transistors per photoelectric conversion unit PD in the pixel 12 (the ratio of the number of transistors to the number of photoelectric conversion units PD) may be reduced, and for example, the pixel 12 may be miniaturized.

Similarly to FIG. 4, FIG. 7 is a plan view of the semiconductor layer (semiconductor substrate) provided with elements constituting the pixel circuit as viewed from the front face side. An insulator isolation portion 122 defining active regions 124, 126, and 128 is provided in the front face (first face) of the semiconductor layer 120. The photoelectric conversion unit PDA and the transfer transistor M1A are provided in the active region 124A. In FIG. 7, a region above the gate electrode of the transfer transistor M1A is a source region of the transfer transistor M1A including the photoelectric conversion unit PDA, and a region below the gate electrode of the transfer transistor M1A is a drain region of the transfer transistor M1A. In addition, the photoelectric conversion unit PDB and the transfer transistor M1B are provided in the active region 124B. In FIG. 7, a region below the gate electrode of the transfer transistor M1B is a source region of the transfer transistor M1B including the photoelectric conversion unit PDB, and a region above the gate electrode of the transfer transistor M1B is a drain region of the transfer transistor M1B. In the active region 126, 128, 130A and 130B, the reset transistor M2, the amplifier transistor M3, the select transistor M41, and the select transistor M42 are provided, respectively.

The active region 124A and the active region 124B are arranged in a direction parallel to the Y direction so that the drain region side of the transfer transistor M1A and the drain region side of the transfer transistor M1B face each other. The active regions 124A and 124B may include a connecting portion 124C that connects the drain region of the transfer transistor M1A and the drain region of the transfer transistor M1B. In this case, the active regions 124A and 124B, and the connecting portion 124C constitute one continuous active region 124. Further, in one example, each of the active region 124A and the active region 124B, the gate electrode of the transfer transistor M1A and the gate electrode of the transfer transistor M1B, and the photoelectric conversion unit PDA and the photoelectric conversion unit PDB may be arranged line-symmetrically with respect to an imaginary straight line A-A′ extending in the X direction as a symmetry axis. However, each of the active region 124A and the active region 124B, the gate electrode of the transfer transistor M1A and the gate electrode of the transfer transistor M1B, and the photoelectric conversion unit PDA and the photoelectric conversion unit PDB may not necessarily be arranged in line symmetry. End portions of the gate width direction of the gate electrode of the transfer transistor M1A and the gate electrode of the transfer transistor M1B may be located over the insulator isolation portion 122 or may be located over the active regions 124A and 124B. Note that the active regions 124A and 124B are not necessarily formed of one continuous active region 124 and may be independent from each other. In this case, the drain region of the transfer transistor M1A and the drain region of the transfer transistor M1B may be electrically connected to each other via an interconnection.

The active region 126 is arranged adjacent to the active region 124 in the X direction. The active region 126 has a shape elongated in the Y direction, and the reset transistor M2 is provided in the active region 126 so that the gate length direction thereof is parallel to the Y direction. The gate electrode of the reset transistor M2 is arranged on a imaginary straight line B-B′ that passes through the center between the photoelectric conversion unit PDB and the photoelectric conversion unit PDA of another pixel 12 adjacent in the −Y direction and extends in the X direction. In other words, the photoelectric conversion unit PDB and the photoelectric conversion unit PDA of the pixel 12 adjacent in the −Y direction are arranged at symmetrical positions with respect to the gate electrode of the reset transistor M2.

In the present embodiment, the gate electrode of the reset transistor M2 is arranged so as to face the photoelectric conversion unit PDB and the photoelectric conversion unit PDA of the pixel 12 adjacent in the −Y direction. Therefore, when the reset transistor M2 is turned on, the dark current flowing into the photoelectric conversion units PDA and PDB may increase. Specifically, the electric field from the gate electrode of the reset transistor M2 set to high-level may decrease the hole density at the interface with the insulator isolation portion 122 and increase the dark current. If the dark current flows into the photoelectric conversion units PDA and PDB, a noise component superimposed on the signal charge may increase. However, in the present embodiment, the photoelectric conversion unit PDA of the pixel 12 adjacent to the photoelectric conversion unit PDB in the −Y direction is arranged at a symmetrical position with respect to the gate electrode of the reset transistor M2. Therefore, the amount of dark current flowing into the photoelectric conversion units PDA and PDB during the operation of the reset transistor M2 may be made equal to each other, and the stripe-shaped fixed pattern noise superimposed on the captured image according to the driving of the reset transistor M2 may be reduced.

As described above, according to the present embodiment, the same effects as those of the first embodiment may be obtained, and the influence of noise generated due to the driving of the transistors constituting the pixel circuit may be further reduced.

### THIRD EMBODIMENT

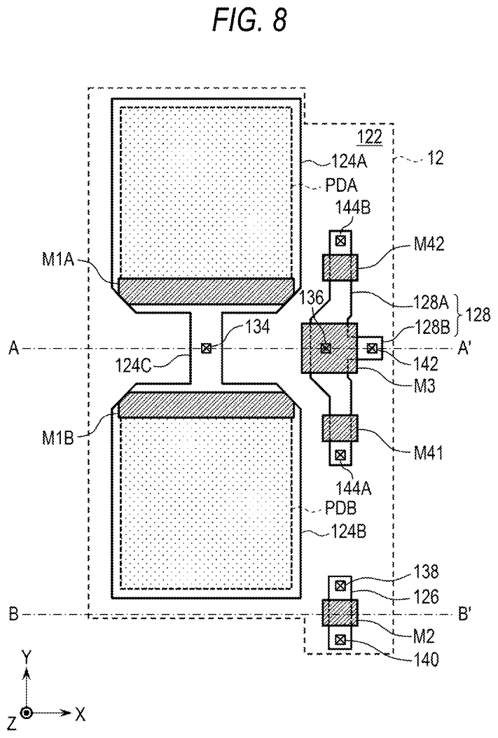

A photoelectric conversion device according to a third embodiment will be described with reference to FIG. 8. The same components as those of the photoelectric conversion device according to the first or second embodiment are denoted by the same reference numerals, and description thereof will be omitted or simplified.

The photoelectric conversion device according to the present embodiment is the same as the photoelectric conversion device according to the second embodiment except that the layout of the pixel 12 is different. In the present embodiment, differences from the photoelectric conversion device according to the second embodiment will be mainly described, and description of points similar to those of the photoelectric conversion device according to the first or second embodiment will be appropriately omitted.

Similarly to FIG. 4, FIG. 8 is a plan view of the semiconductor layer (semiconductor substrate) in which each element constituting the pixel circuit is provided, as viewed from the front face side. In the second embodiment, the amplifier transistor M3 and the select transistors M41 and M42 are arranged in the different active regions. On the other hand, in the present embodiment, the amplifier transistor M3 is configured to have one drain region and two source regions, so that the amplifier transistor M3 and the select transistors M41 and M42 are arranged in one active region 128. The arrangement of the other elements may be the same as that of the pixel 12 of the second embodiment.

The active region 128 has a first portion 128A extending in the Y direction and arranged adjacent to the active regions 124A and 124B in the X direction, and a second portion 128B extending in the X direction from a central portion of the first portion. The gate electrode of the amplifier transistor M3 is arranged at the center of the first portion 128A. The gate electrodes of the select transistors M41 and M42 are respectively arranged at upper and lower portions of the first portion 128A so that the gate electrode of the amplifier transistor M3 is located therebetween. A region of the first portion 128A between the gate electrode of the amplifier transistor M3 and the gate electrode of the select transistor M41 corresponds to the first source region of the amplifier transistor M3 and the drain region of the select transistor M41. A region of the first portion 128A between the gate electrode of the amplifier transistor M3 and the gate electrode of the select transistor M42 corresponds to the second source region of the amplifier transistor M3 and the drain region of the select transistor M42. The second portion 128B corresponds to the drain region of the amplifier transistor M3.

This configuration eliminates the need for the interconnection 152 that connects the source region of the amplifier transistor M3, the drain region of the select transistor M41, and the drain region of the select transistor M42. Accordingly, it is possible to reduce the interconnection density in the pixel 12, to reduce the possibility of occurrence of a defect such as an unintended short circuit between interconnections at the time of metallization processing, and to improve the manufacturing yield.

As described above, according to the present embodiment, the same effects as those of the second embodiment may be obtained, and the manufacturing yield of the photoelectric conversion device may be improved.

### FOURTH EMBODIMENT

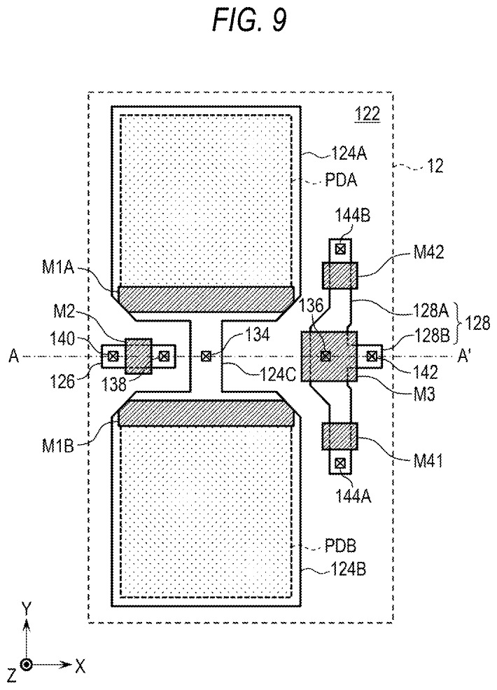

A photoelectric conversion device according to a fourth embodiment will be described with reference to FIG. 9. The same components as those of the photoelectric conversion devices according to the first to third embodiments are denoted by the same reference numerals, and description thereof will be omitted or simplified.

The photoelectric conversion device according to the present embodiment is the same as the photoelectric conversion device according to the third embodiment except that the layout of the pixel 12 is different. In the present embodiment, differences from the photoelectric conversion device according to the third embodiment will be mainly described, and description of points similar to those of the photoelectric conversion devices according to the first to third embodiments will be appropriately omitted.

Similarly to FIG. 4, FIG. 9 is a plan view of the semiconductor layer (semiconductor substrate) in which each element constituting the pixel circuit is provided, as viewed from the front face side. In the second and third embodiments, the reset transistor M2 is arranged adjacent to the active region 124 in the X direction. In contrast, in the present embodiment, the transfer transistors M1A and M1B and the reset transistor M2 are arranged such that the gate electrode of the reset transistor M2 is located between the gate electrode of the transfer transistor M1A and the gate electrode of the transfer transistor M1B. The arrangement of the other elements may be the same as that of the pixel 12 of the second or third embodiment.

The active region 126 is arranged between the active region 124A and the active region 124B. The active region 126 has a rectangular shape elongated in the X direction, and the reset transistor M2 is provided in the active region 126 so that the gate length direction thereof is parallel to the X direction. At least a part of the gate electrode of the reset transistor M2 faces the gate electrode of the transfer transistor M1A and the gate electrode of the transfer transistor M1B. In other words, the gate electrode of the transfer transistor M1A is arranged between the photoelectric conversion unit PDA and the gate electrode of the reset transistor M2. The gate electrode of the transfer transistor M1B is arranged between the photoelectric conversion unit PDB and the gate electrode of the reset transistor M2.

As described above, in the present embodiment, the gate electrode of the transfer transistor M1A is arranged between the photoelectric conversion unit PDA and the gate electrode of the reset transistor M2. The gate electrode of the transfer transistor M1B is arranged between the photoelectric conversion unit PDB and the gate electrode of the reset transistor M2. With such an arrangement, it is possible to reduce the influence of the voltage change of the gate electrode of the reset transistor M2 on the photoelectric conversion units PDA and PDB.

That is, in a case where the gate electrode of the reset transistor M2 and the photoelectric conversion units PDA and PDB are opposed to each other, the dark current may increase around the photoelectric conversion units PDA and PDB by turning on the reset transistor M2. Specifically, the electric field from the gate electrode of the reset transistor M2 set to high-level may decrease the hole density at the interface of the portion of the insulator isolation portion 122 facing the n-type semiconductor region 168 and increase the dark current. If the dark current flows into the photoelectric conversion units PDA and PDB, a noise component superimposed on the signal charge may increase.

In this regard, in the present embodiment, since the gate electrodes of the transfer transistors M1A and M1B are arranged between the photoelectric conversion units PDA and PDB and the gate electrode of the reset transistor M2, it is possible to reduce the influence of the voltage change of the gate electrode of the reset transistor M2. For example, in a period in which the photoelectric conversion units PDA and PDB accumulate signal charges, the gate electrodes of the transfer transistors M1A and M1B are held at an off-state voltage. Therefore, even if the reset transistor M2 is turned on during this period, the influence of the voltage change of the gate electrode is blocked by the gate electrodes of the transfer transistors M1A and M1B, and therefore, it is possible to suppress an increase in dark current around the photoelectric conversion units PDA and PDB. Accordingly, noise superimposed on the output signal of the photoelectric conversion device may be reduced.

As described above, according to the present embodiment, the same effects as those of the first embodiment may be obtained, and the noise superimposed on the output signal of the photoelectric conversion device due to the operation of the reset transistor M2 may be reduced.

### FIFTH EMBODIMENT

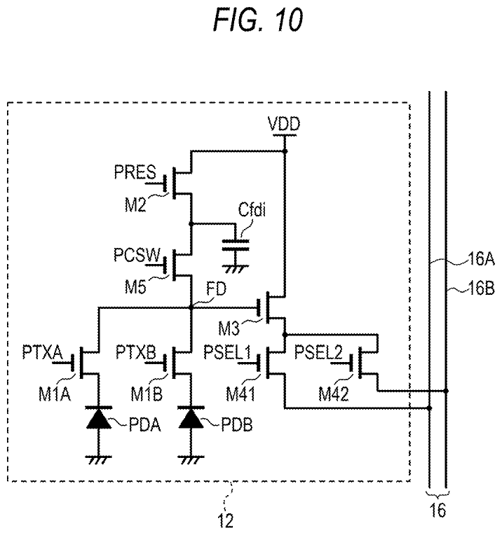

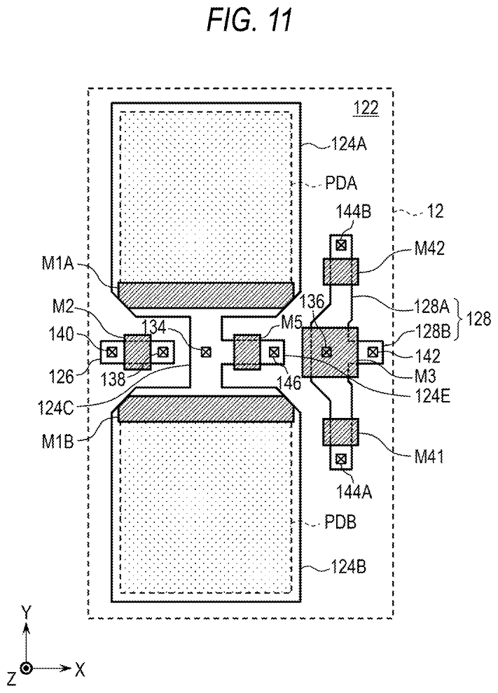

A photoelectric conversion device according to a fifth embodiment will be described with reference to FIG. 10 and FIG. 11. The same components as those of the photoelectric conversion devices according to the first to fourth embodiments are denoted by the same reference numerals, and description thereof will be omitted or simplified.

The photoelectric conversion device according to the present embodiment is the same as the photoelectric conversion device according to the fourth embodiment except that the configuration of the pixel 12 is different. In the present embodiment, differences from the photoelectric conversion device according to the fourth embodiment will be mainly described, and description of points similar to those of the photoelectric conversion devices according to the first to fourth embodiments will be appropriately omitted.

FIG. 10 is an equivalent circuit diagram illustrating a configuration example of the pixel 12 in the photoelectric conversion device according to the present embodiment. As illustrated in FIG. 10, the pixel 12 of the present embodiment further includes a capacitance switching transistor M5 and a capacitor Cfdi in addition to the pixel 12 of the second to fourth embodiments. A source of the capacitance switching transistor M5 is connected to the node FD. A drain of the capacitance switching transistor M5 is connected to the source of the reset transistor M2. One electrode of the capacitor Cfdi is connected to a connection node between the source of the reset transistor M2 and the drain of the capacitance switching transistor M5. The other electrode of the capacitor Cfdi is connected to the ground voltage node.

The connection mode of the capacitance switching transistor M5 and the capacitor Cfdi is not limited to the example of FIG. 10. For example, in the pixel circuit of FIG. 3, the drain of the capacitance switching transistor M5 may be connected to the node FD, the source of the capacitance switching transistor M5 may be connected to one electrode of the capacitor Cfdi, and the other electrode of the capacitor Cfdi may be connected to the ground voltage node.

In the case of the pixel configuration of the present embodiment, the control line 14 of each row may be constituted by a total of six signal lines further including a signal line for supplying a control signal PCSW to a gate of the capacitance switching transistor M5 of the corresponding row. In a case where the capacitance switching transistor M5 is formed of an n-channel transistor, the capacitance switching transistor M5 is turned on when a high-level control signal PCSW is supplied from the vertical scanning circuit 20 and is turned off when a low-level control signal PCSW is supplied from the vertical scanning circuit 20. When the capacitance switching transistor M5 is turned on, the capacitor Cfdi is connected to the node FD, and the capacitance value of the capacitance coupled to the node FD increases. As a result, it is possible to reduce the conversion efficiency from the charge to the voltage in the node FD, and it is possible to suppress the whiteout of the image when imaging a bright object.

The capacitor Cfdi is not particularly limited and may be, for example, a parasitic capacitor, a metal-oxide-semiconductor (MOS) capacitor, a metal-insulator-metal (MIM) capacitor, or a polysilicon-oxide-metal (POM) capacitor.

Similarly to FIG. 4, FIG. 11 is a plan view of the semiconductor layer (semiconductor substrate) in which each element constituting the pixel circuit is provided, as viewed from the front face side. In the present embodiment, the active region 124 further includes an extending portion 124E extending in the X direction from the connecting portion 124C connecting the drain region of the transfer transistor M1A and the drain region of the transfer transistor M1B. The capacitance switching transistor M5 is provided in the extending portion 124E. That is, the drain regions of the transfer transistors M1A and M1B are also a source region of the capacitance switching transistor M5. The capacitance switching transistor M5 is provided in the extending portion 124E of the active region 124 so that the gate length direction thereof is parallel to the X direction. At least a part of the gate electrode of the capacitance switching transistor M5 faces the gate electrode of the transfer transistor M1A and the gate electrode of the transfer transistor M1B. In other words, the gate electrode of the transfer transistor M1A is arranged between the photoelectric conversion unit PDA and the gate electrode of the capacitance switching transistor M5. The gate electrode of the transfer transistor M1B is arranged between the photoelectric conversion unit PDB and the gate electrode of the capacitance switching transistor M5.

The drain regions of the transfer transistors M1A and M1B and the source region of the capacitance switching transistor M5 are electrically connected to the gate electrode of the amplifier transistor M3 via the contact plug 134, an interconnection (not illustrated), and the via plug 136. The drain region of the capacitance switching transistor M5 is electrically connected to the source region of the reset transistor M2 and the capacitor Cfdi via a contact plug 146, an interconnection (not illustrated), the contact plug 138, and the like.

In the present embodiment, the gate electrode of the transfer transistor M1A is arranged between the photoelectric conversion unit PDA and the gate electrode of the capacitance switching transistor M5. The gate electrode of the transfer transistor M1B is arranged between the photoelectric conversion unit PDB and the gate electrode of the capacitance switching transistor M5. By arranging the gate electrode of the capacitance switching transistor M5 in this manner, it is possible to reduce the influence of the voltage change of the gate electrode of the capacitance switching transistor M5, as in the case of the gate electrode of the reset transistor M2 in the fourth embodiment. For example, in a period in which the photoelectric conversion units PDA and PDB accumulate signal charges, the gate electrodes of the transfer transistors M1A and M1B are held at an off-state voltage. Therefore, even if the capacitance switching transistor M5 is turned on during this period, the influence of the voltage change of the gate electrode is blocked by the gate electrodes of the transfer transistors M1A and M1B, and therefore, an increase in dark current around the photoelectric conversion units PDA and PDB may be suppressed.

In the present embodiment, the gate electrode of the reset transistor M2, the gate electrode of the capacitance switching transistor M5, the node FD, and the gate electrode of the amplifier transistor M3 are arranged so as to be aligned in the X direction. On the other hand, of these, only the gate electrode of the amplifier transistor M3 is not located between the gate electrodes of the transfer transistors M1A and M1B. With this arrangement, the parasitic capacitance between the gate electrode of the amplifier transistor M3 and the gate electrodes of the transfer transistors M1A and M1B, that is, the capacitance of the node FD may be reduced, and the conversion efficiency from the charge amount to the voltage in the node FD may be increased.

As described above, according to the present embodiment, even when the pixel 12 further includes the capacitance switching transistor, the same effects as those of the first to fourth embodiments may be obtained.

### SIXTH EMBODIMENT

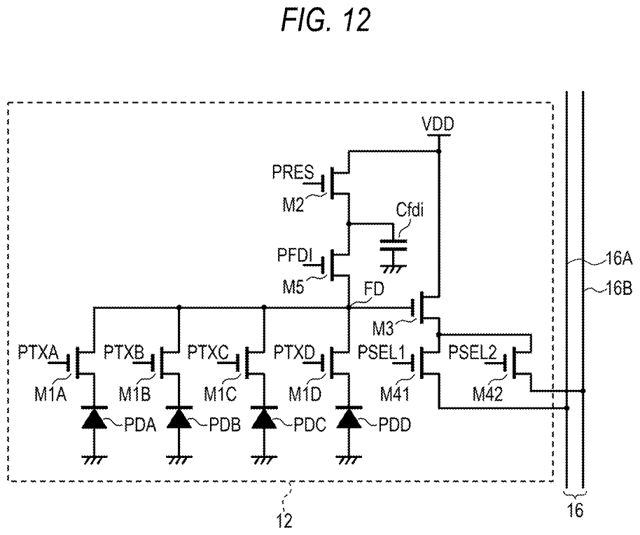

A photoelectric conversion device according to a sixth embodiment will be described with reference to FIG. 12 to FIG. 14. The same components as those of the photoelectric conversion devices according to the first to fifth embodiments are denoted by the same reference numerals, and description thereof will be omitted or simplified.

The photoelectric conversion device according to the present embodiment is the same as the photoelectric conversion device according to the first to fifth embodiments except that the configuration of the pixel 12 is different. In the present embodiment, differences from the photoelectric conversion devices according to the first to fifth embodiments will be mainly described, and description of points similar to those of the photoelectric conversion devices according to the first to fifth embodiments will be appropriately omitted.

FIG. 12 is an equivalent circuit diagram illustrating a configuration example of the pixel 12 in the photoelectric conversion device according to the present embodiment. The pixel 12 of the fifth embodiment includes two sets of photoelectric conversion units PD and transfer transistors M1 sharing the node FD, the capacitance switching transistor M5, the reset transistor M2, the amplifier transistor M3, and the select transistors M41 and M42. On the other hand, as illustrated in FIG. 12, the pixel 12 of the present embodiment includes four sets of photoelectric conversion units PD and transfer transistors M1 that share the node FD, the capacitance switching transistor M5, the reset transistor M2, the amplifier transistor M3, and the select transistors M41 and M42. That is, the pixel 12 of the present embodiment further includes photoelectric conversion units PDC and PDD and transfer transistors M1C and M1D in addition to the pixel 12 of the fifth embodiment.

The photoelectric conversion unit PDC has an anode connected to the ground voltage node and a cathode connected to a source of the transfer transistor M1C. The photoelectric conversion unit PDD has an anode connected to the ground voltage node and a cathode connected to a source of the transfer transistor M1D. Drains of the transfer transistors M1C and M1D are connected to the drains of the transfer transistors M1A and M1B, the source of the capacitance switching transistor M5, and the gate of the amplifier transistor M3. A node to which the drains of the transfer transistors M1A, M1B, M1C, and M1D, the source of the capacitance switching transistor M5, and the gate of the amplifier transistor M3 are connected is the node FD.

In the case of the pixel configuration of the present embodiment, the control line 14 of each row may be constituted by a total of eight signal lines further including a signal line for supplying a control signal PTXC to the transfer transistor M1C and a signal line for supplying a control signal PTXD to the transfer transistor M1D. When the transfer transistors M1C and M1D are formed of n-channel transistors, they are turned on when the control signals PTXC and PTXD of high-level are supplied and are turned off when the control signals PTXC and PTXD of low-level are supplied. Other circuit configurations of the pixel 12 of the present embodiment may be the same as those of the pixel 12 of the fifth embodiment.

It may be also considered that the pixel circuit of FIG. 12 includes the pixel 12 including the photoelectric conversion units PDA and PDB and the transfer transistors M1A and M1B, and the pixel 12 including the photoelectric conversion units PDC and PDD and the transfer transistors M1C and M1D. In this case, the two pixels 12 share one set of the node FD, the capacitance switching transistor M5, the reset transistor M2, the amplifier transistor M3, and the select transistors M41 and M42. By applying such a configuration, it is possible to further reduce the number of transistors per photoelectric conversion unit PD in the pixel 12 (a ratio of the number of transistors to the number of photoelectric conversion units PD) as compared with the first to fifth embodiments, and it is possible to miniaturize the pixel 12, for example.

In the following description, it is assumed that the pixel 12 including the photoelectric conversion units PDA and PDB and the transfer transistors M1A and M1B and the pixel 12 including the photoelectric conversion units PDC and PDD and the transfer transistors M1C and M1D are arranged in adjacent rows of the same column. In the following description, it is also assumed that the photoelectric conversion units PDA and PDB share one microlens and the photoelectric conversion units PDC and PDD share another microlens.

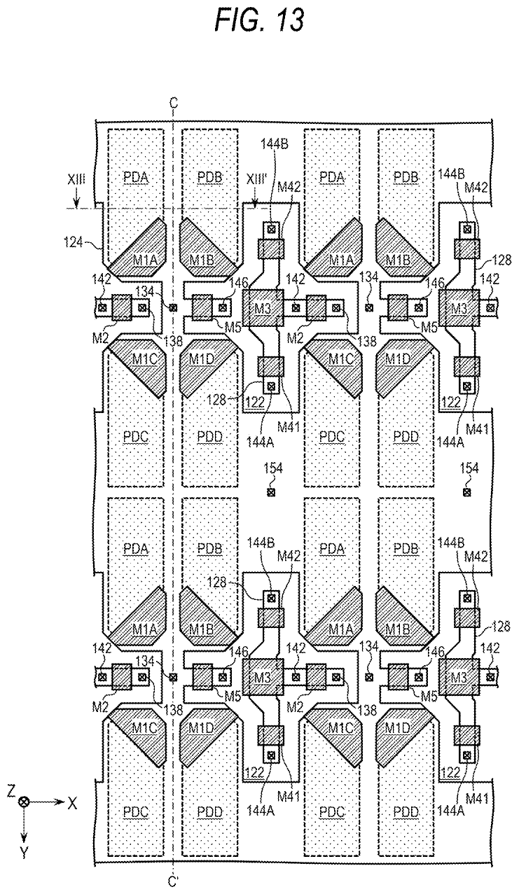

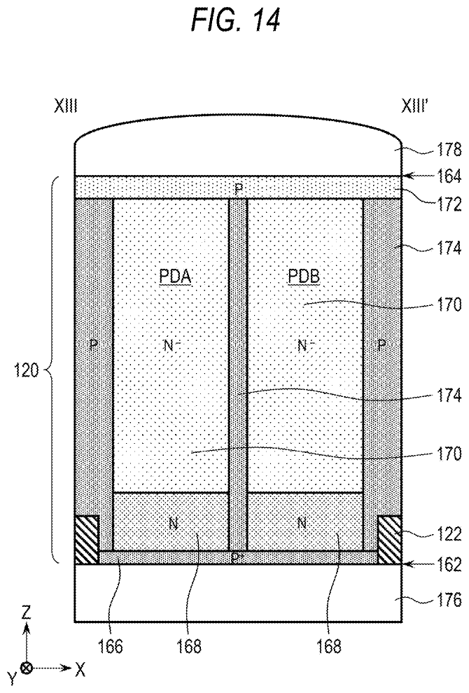

Next, the structure of the pixel 12 in the photoelectric conversion device according to the present embodiment will be described more specifically with reference to FIG. 13 and FIG. 14 by taking a back-illuminated photoelectric conversion device as an example. Although an example in which the configuration of the present embodiment is applied to a back-illuminated photoelectric conversion device will be described here, the configuration of the present embodiment may also be applied to a front-illuminated photoelectric conversion device.

Similarly to FIG. 4, FIG. 13 is a plan view of the semiconductor layer (semiconductor substrate) provided with each element constituting the pixel circuit as viewed from the front face side. The layout illustrated in FIG. 13 is basically the same as the layout of the fifth embodiment except that the photoelectric conversion unit PD and the transfer transistor M1 are divided into two parts in the X direction. That is, the photoelectric conversion unit PDA and the transfer transistor M1A in FIG. 11 are divided into two in the X direction and correspond to the photoelectric conversion units PDA and PDB and the transfer transistors M1A and M1B in FIG. 13. The photoelectric conversion unit PDB and the transfer transistor M1B in FIG. 11 are divided into two parts in the X direction and correspond to the photoelectric conversion units PDC and PDD and the transfer transistors M1C and M1D in FIG. 13. The photoelectric conversion unit PDA and the transfer transistor M1A and the photoelectric conversion unit PDB and the transfer transistor M1B are arranged line-symmetrically with respect to an imaginary straight line C-C′ extending in the Y direction as an axis of symmetry. In addition, the photoelectric conversion unit PDC and the transfer transistor M1C and the photoelectric conversion unit PDD and the transfer transistor M1D are arranged line-symmetrically with respect to the straight line C-C′ extending in the Y direction as an axis of symmetry.

By arranging the photoelectric conversion units PDA and PDB in this manner and configuring the photoelectric conversion units PDA and PDB to share one microlens, it is possible to perform phase difference detection in the X direction based on a signal based on charges generated by the photoelectric conversion units PDA and PDB. By adding the signal based on the charge generated by the photoelectric conversion unit PDA and the signal based on the charge generated by the photoelectric conversion unit PDB, the imaging signal may be acquired. In a case where the photoelectric conversion units PDC and PDD are also configured to share another microlens, phase difference detection in the X direction may be performed based on a signal based on charges generated by the photoelectric conversion units PDC and PDD. By adding the signal based on the charge generated by the photoelectric conversion unit PDC and the signal based on the charge generated by the photoelectric conversion unit PDD, the imaging signal may be acquired.

In the layout of FIG. 13, since the drain region of the reset transistor M2 to which the voltage VDD is supplied and the drain region of the amplifier transistor M3 are shared, the active regions 126 and 128 of FIG. 11 are one active region 128 in FIG. 13. This layout has advantages of reducing the areas of the drain regions of the reset transistor M2 and the amplifier transistor M3 and reducing one contact plug. In addition, the reference voltage (ground voltage) supplied to the p-type semiconductor region 174 constituting the anodes of the photoelectric conversion units PDA, PDB, PDC, and PDD may be supplied via, for example, the contact plug 154.

FIG. 14 is a schematic cross-sectional view illustrating the structure of the photoelectric conversion units PDA and PDB that corresponds to, for example, a cross-sectional view taken along line XIII-XIII′ of FIG. 13. FIG. 14 illustrates only the photoelectric conversion units PDA and PDB, but the same applies to the photoelectric conversion units PDC and PDD.

The semiconductor layer 120 provided with the photoelectric conversion units PDA, PDB, PDC, and PDD has a first face 162 on the front face side and a second face 164 on the back face side. The semiconductor layer 120 includes p-type semiconductor regions 166, 172, and 174, n-type semiconductor regions 168 and 170, and an insulator isolation portion 122.

The n-type semiconductor regions 168 and 170 function as cathodes of photodiodes constituting the photoelectric conversion units PDA and PDB. The n-type semiconductor region 168 is arranged on a side of the first face 162 of the semiconductor layer 120, and the n-type semiconductor region 170 is arranged on a side of the second face 164 of the semiconductor layer 120. The n-type semiconductor region 170 serves as a photoelectric conversion region, and the n-type semiconductor region 168 serves to collect signal charge generated in the n-type semiconductor region 170. For these purposes, the peak impurity concentration of the n-type semiconductor region 168 is set higher than the peak impurity concentration of the n-type semiconductor region 170. The p-type semiconductor region 174 is provided on side faces of the n-type semiconductor regions 168 and 170. The p-type semiconductor region 174 constitutes anodes of photodiodes constituting the photoelectric conversion units PDA, PDB, PDC, and PDD, and also has a role of isolating adjacent photoelectric conversion units PDA, PDB, PDC, and PDD.

The p-type semiconductor region 166 is provided in contact with the first face 162 of the semiconductor layer 120. The p-type semiconductor region 172 is provided in contact with the second face 164 of the semiconductor layer 120. The p-type semiconductor regions 166 and 172 have a function of suppressing a dark current generated on the first face 162 and the second face 164, respectively. The peak impurity concentration of the p-type semiconductor region 166 is set higher than the peak impurity concentration of the p-type semiconductor region 172. The insulator isolation portion 122 is provided in the surface portion of the first face 162 of the semiconductor layer 120 and has a role of isolating the transistors and the photoelectric conversion units PDA, PDB, PDC, and PDD from each other. The insulator isolation portion 122 is surrounded by the p-type semiconductor regions 166 and 174.

An optical structure layer 178 including the color filters, the microlenses, and the like is provided over the second face 164 of the semiconductor layer 120. An interconnection structure layer 176 including a gate layer constituting the gate electrodes of the transistors and metal interconnection layers is provided over a side of the first face 162 of the semiconductor layer 120. A circuit substrate 180 and a support substrate (both not illustrated) may be further provided on the side of the first face 162 of the semiconductor layer 120.

In a case where the back-illuminated photoelectric conversion device is configured as in the present embodiment, the interconnection structure layer 176 is not arranged over the second face 164 which is the light-receiving surface of the semiconductor layer 120. Therefore, it is possible to prevent the light incident on the photoelectric conversion device from being blocked by the interconnection constituting the interconnection structure layer 176, and it is possible to improve the light receiving efficiency in the photoelectric conversion units PDA, PDB, PDC, and PDD.

As described above, according to the present embodiment, the same effects as those of the fifth embodiment may be obtained, and miniaturization of the pixel 12 and improvement in sensitivity may be realized.

### SEVENTH EMBODIMENT

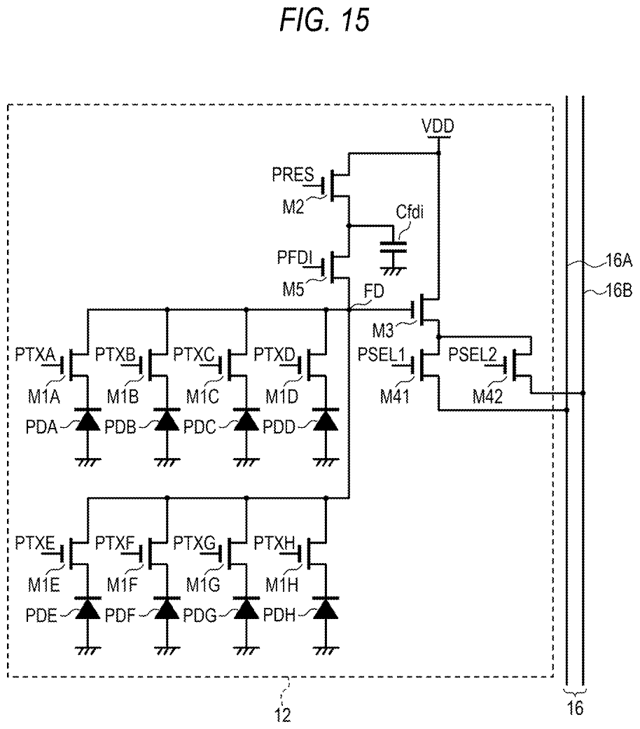

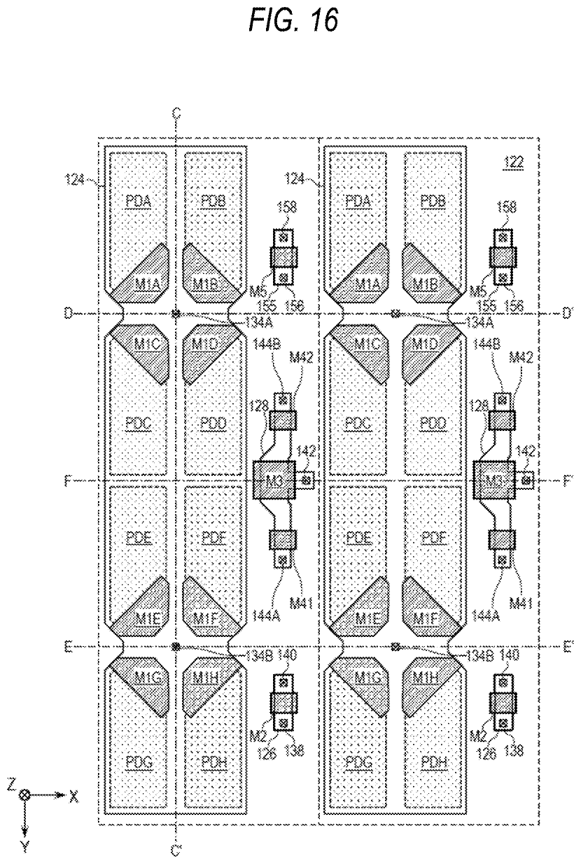

A photoelectric conversion device according to a seventh embodiment will be described with reference to FIG. 15 and FIG. 16. The same components as those of the photoelectric conversion devices according to the first to sixth embodiments are denoted by the same reference numerals, and description thereof will be omitted or simplified.

The photoelectric conversion device according to the present embodiment is the same as the photoelectric conversion device according to the first to sixth embodiments except that the configuration of the pixel 12 is different. In the present embodiment, differences from the photoelectric conversion devices according to the first to sixth embodiments will be mainly described, and description of points similar to those of the photoelectric conversion devices according to the first to sixth embodiments will be appropriately omitted.

FIG. 15 is an equivalent circuit diagram illustrating a configuration example of the pixel 12 in the photoelectric conversion device according to the present embodiment. The pixel 12 of the fifth embodiment includes two sets of photoelectric conversion units PD and transfer transistors M1 sharing the node FD, the capacitance switching transistor M5, the reset transistor M2, the amplifier transistor M3, and the select transistors M41 and M42. In addition, the pixel 12 according to the sixth embodiment includes four sets of the photoelectric conversion unit PD and the transfer transistor M1 that share the node FD, the capacitance switching transistor M5, the reset transistor M2, the amplifier transistor M3, and the select transistors M41 and M42. On the other hand, the pixel 12 of the present embodiment includes eight sets of photoelectric conversion units PD and transfer transistors M1 that share the node FD, the capacitance switching transistor M5, the reset transistor M2, the amplifier transistor M3, and the select transistors M41 and M42. That is, the pixel 12 of the present embodiment further includes photoelectric conversion units PDE, PDF, PDG, and PDH and transfer transistors M1E, M1F, M1G, and M1H in addition to the pixel 12 of the sixth embodiment.

The photoelectric conversion unit PDE has an anode connected to the ground voltage node and a cathode connected to a source of the transfer transistor M1E. The photoelectric conversion unit PDF has an anode connected to the ground voltage node and a cathode connected to a source of the transfer transistor M1F. The photoelectric conversion unit PDG has an anode connected to the ground voltage node and a cathode connected to a source of the transfer transistor M1G. The photoelectric conversion unit PDH has an anode connected to the ground voltage node and a cathode connected to a source of the transfer transistor M1H. Drains of the transfer transistors M1E, M1F, M1G, and M1H are connected to the drains of the transfer transistors M1A, M1B, M1C, and M1D, the source of the capacitance switching transistor M5, and the gate of the amplifier transistor M3. A node to which the drains of the transfer transistors M1A, M1B, M1C, M1D, M1E, M1F, M1G, and M1H, the source of the capacitance switching transistor M5, and the gate of the amplifier transistor M3 are connected is the node FD.

In the case of the pixel configuration of the present embodiment, the control line 14 of each row may be constituted by a total of twelve signal lines. Specifically, the control line 14 of each row further includes a signal line for supplying a control signal PTXE to the transfer transistor M1E and a signal line for supplying a control signal PTXF to the transfer transistor M1F. The control line 14 of each row further includes a signal line for supplying a control signal PTXG to the transfer transistor M1G and a signal line for supplying a control signal PTXH to the transfer transistor M1H. In a case where the transfer transistors M1E, M1F, M1G, and M1H are n-channel transistors, they are turned on when the high-level control signals PTXE, PTXF, PTXG, and PTXH are supplied from the vertical scanning circuit 20. The transfer transistors M1E, M1F, M1G, and M1H are turned off when the low-level control signals PTXE, PTXF, PTXG, and PTXH are supplied from the vertical scanning circuit 20. Other circuit configurations of the pixel 12 of the present embodiment may be the same as those of the pixel 12 of the sixth embodiment.

It may be also considered that the pixel circuit of FIG. 15 includes the pixel 12 including the photoelectric conversion units PDA and PDB, the pixel 12 including the photoelectric conversion units PDC and PDD, the pixel 12 including the photoelectric conversion units PDE and PDF, and the pixel 12 including the photoelectric conversion units PDG and PDH. In this case, the four pixels 12 share one set of the node FD, the capacitance switching transistor M5, the reset transistor M2, the amplifier transistor M3, and the select transistors M41 and M42. By applying such a configuration, it is possible to further reduce the number of transistors per photoelectric conversion unit PD in the pixel 12 (a ratio of the number of transistors to the number of photoelectric conversion units PD) as compared with the sixth embodiment, and it is possible to miniaturize the pixel 12, for example.

In the following description, it is assumed that the pixel 12 including the photoelectric conversion units PDA and PDB, the pixel 12 including the photoelectric conversion units PDC and PDD, the pixel 12 including the photoelectric conversion units PDE and PDF, and the pixel 12 including the photoelectric conversion units PDG and PDH are arranged in four adjacent rows in the same column. In the following description, it is assumed that each of the photoelectric conversion units PDA and PDB, the photoelectric conversion units PDC and PDD, the photoelectric conversion units PDE and PDF, and the photoelectric conversion units PDG and PDH share one microlens.

Next, the structure of the pixel 12 in the photoelectric conversion device according to the present embodiment will be described more specifically with reference to FIG. 16, taking a back-illuminated photoelectric conversion device as an example. Although an example in which the configuration of the present embodiment is applied to a back-illuminated photoelectric conversion device will be described here, the configuration of the present embodiment may also be applied to a front-illuminated photoelectric conversion device.

Similarly to FIG. 4, FIG. 16 is a plan view of the semiconductor layer (semiconductor substrate) provided with each element constituting the pixel circuit as viewed from the front face side. An insulator isolation portion 122 defining active regions 124, 126, 128 and 155 is provided in the front face (first face) of the semiconductor layer 120. The photoelectric conversion units PDA, PDB, PDC, PDD, PDE, PDF, PDG, and PDH, and the transfer transistors M1A, M1B, M1C, M1D, M1E, M1F, M1G, and M1H are provided in the active region 124. The reset transistor M2 is provided in the active region 126. The amplifier transistor M3 and the select transistors M41 and M42 are provided in the active region 128. The capacitance switching transistor M5 is provided in the active region 155.

In the active region 124, sets of two photoelectric conversion units PD and two transfer transistors M1 constituting each of the four pixels 12 are arranged in the Y direction which is the longitudinal direction of the active region 124. Each of the photoelectric conversion units PDA and PDB, the photoelectric conversion units PDC and PDD, the photoelectric conversion units PDE and PDF, and the photoelectric conversion units PDG and PDH are arranged line-symmetrically with respect to an imaginary straight line C-C′ extending in the Y direction. Similarly, each of the transfer transistors M1A and M1B, the transfer transistors M1C and M1D, the transfer transistors M1E and M1F, and the transfer transistors M1G and M1H are also arranged line-symmetrically with respect to the straight line C-C′. The photoelectric conversion units PDA and PDB and the transfer transistors M1A and M1B, and the photoelectric conversion units PDC and PDD and the transfer transistors M1C and M1D are arranged line-symmetrically with respect to an imaginary straight line D-D′ extending in the X direction as a symmetry axis. Similarly, the photoelectric conversion units PDE and PDF and the transfer transistors M1E and M1F, and the photoelectric conversion units PDG and PDH and the transfer transistors M1G and M1H are arranged line-symmetrically with respect to an imaginary straight line E-E′ extending in the X direction as a symmetry axis.

The active regions 126, 128, and 155 are arranged adjacent to the active region 124 in the X direction. The active region 126 has a shape elongated in the Y direction, and the reset transistor M2 is provided in the active region 126 so that the gate length direction thereof is parallel to the Y direction. The reset transistor M2 is arranged between the photoelectric conversion unit PDH and the photoelectric conversion unit PDG of the pixels 12 adjacent to each other in the X direction. The active region 128 has a shape similar to that of the third embodiment. The arrangement of the amplifier transistor M3 and the select transistors M41 and M42 provided in the active region 128 is also the same as in the third embodiment. The amplifier transistor M3 is arranged on an imaginary straight line F-F′ extending in the X direction passing through the center between the photoelectric conversion units PDC and PDD and the photoelectric conversion units PDE and PDF. The select transistor M41 is arranged between the photoelectric conversion unit PDE and the photoelectric conversion unit PDF of the pixels 12 adjacent to each other in the X direction. The select transistor M42 is arranged between the photoelectric conversion unit PDC and the photoelectric conversion unit PDD of the pixels 12 adjacent to each other in the X direction. The active region 155 has a shape elongated in the Y direction, and the capacitance switching transistor M5 is provided in the active region 155 so that the gate length direction thereof is parallel to the Y direction. The capacitance switching transistor M5 is arranged between the photoelectric conversion unit PDA and the photoelectric conversion unit PDB of the pixels 12 adjacent to each other in the X direction.

The drain regions of the transfer transistors M1A, M1B, M1C, and M1D are electrically connected to an interconnection (not illustrated) via a contact plug 134A. The drain regions of the transfer transistors M1E, M1F, M1G, and M1H are electrically connected to the interconnection (not illustrated) via a contact plug 134B. The source region of the capacitance switching transistor M5 is electrically connected to the interconnection (not illustrated) via the contact plug 156. The gate electrode of the amplifier transistor M3 is electrically connected to the interconnection (not illustrated) via a via plug (not illustrated). A node to which the drains of the transfer transistors M1A, M1B, M1C, M1D, M1E, M1F, M1G, and M1H, the source of the capacitance switching transistor M5, and the gate of the amplifier transistor M3 are electrically connected is the node FD.

The drain region of the capacitance switching transistor M5 is connected to the source region of the reset transistor M2 via a contact plug 158, an interconnection (not illustrated), and the contact plug 138. The drain region of the reset transistor M2 is supplied with the voltage VDD via an interconnection (not illustrated) and the contact plug 140. The drain region of the amplifier transistor M3 is supplied with the voltage VDD via an interconnection (not illustrated) and the contact plug 142. The source region of the select transistor M41 is connected to the signal line 16A via the contact plug 144A. The source region of the select transistor M42 is connected to the signal line 16B via the contact plug 144B.

As described above, in the present embodiment, the gate electrode of the reset transistor M2, the gate electrode of the select transistor M41, the gate electrode of the select transistor M42, and the gate electrode of the capacitance switching transistor M5 face different photoelectric conversion units PD. Therefore, it is possible to sufficiently suppress the difference in the amount of dark current flowing into each photoelectric conversion unit PD when the reset transistor M2, the select transistors M41 and M42, and the capacitance switching transistor M5 are turned on.

Although the gate electrode of the amplifier transistor M3 also faces a part of the photoelectric conversion units PDD and PDF, the facing length between the gate electrode of the amplifier transistor M3 and the photoelectric conversion units PDD and PDF is sufficiently shorter than the facing length between the gate electrode of the other transistor and the photoelectric conversion unit PD. Therefore, the dark current flowing into the photoelectric conversion units PDD and PDF due to the operation of the amplifier transistor M3 is small, and the influence on the amount of the dark current flowing into each photoelectric conversion unit PD is sufficiently small.

As described above, according to the present embodiment, the same effects as those of the fifth embodiment may be obtained, and miniaturization of the pixel 12 and improvement in sensitivity may be realized.

### EIGHTH EMBODIMENT

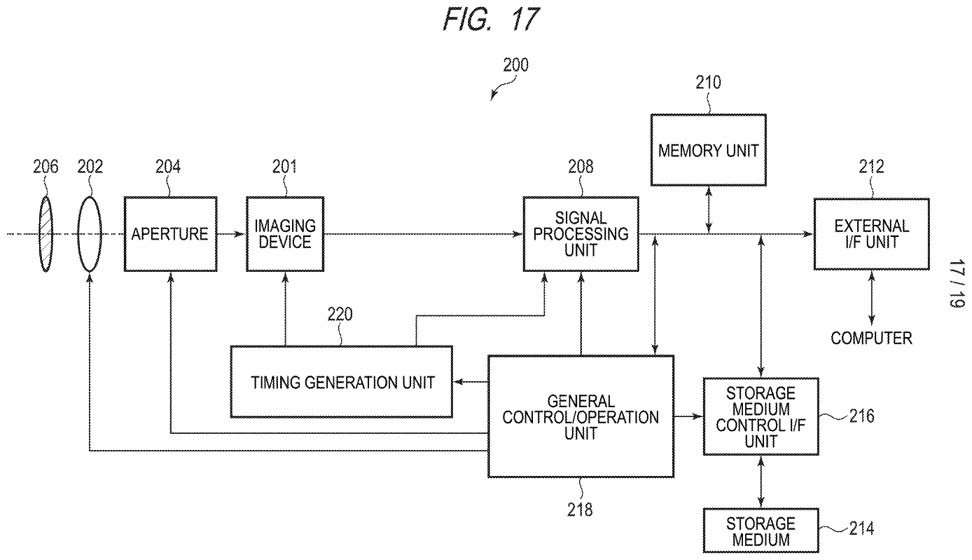

A photoelectric conversion system according to an eighth embodiment will be described with reference to FIG. 17. FIG. 17 is a block diagram illustrating a schematic configuration of a photoelectric conversion system according to the present embodiment.

The photoelectric conversion device 100 described in the first to seventh embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 17 exemplifies a block diagram of a digital still camera as one of these.

The photoelectric conversion system 200 illustrated in FIG. 17 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 constitute an optical system that focuses light onto the imaging device 201. The imaging device 201 is the photoelectric conversion device 100 described in any of the first to seventh embodiments, and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer (semiconductor substrate) different from the semiconductor layer on which the photoelectric conversion unit of the imaging device 201 is formed. The signal processing unit 208 may be formed on the same semiconductor layer as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201 and outputs the processed image data. The signal processing unit 208 generates an image using the imaging signal.

As described above, according to the present embodiment, it is possible to realize a photoelectric conversion system to which the photoelectric conversion device 100 according to any of the first to seventh embodiments is applied.

### NINTH EMBODIMENT

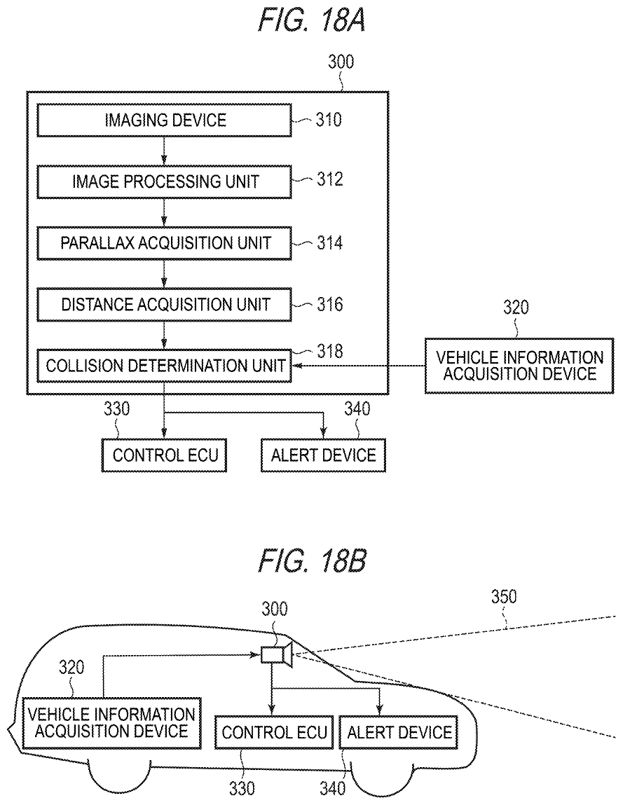

The photoelectric conversion system and a movable object according to a ninth embodiment will be described with reference to FIG. 18A and FIG. 18B. FIG. 18A is a diagram illustrating a configuration of a photoelectric conversion system according to the present embodiment. FIG. 18B is a diagram illustrating a configuration of a movable object according to the present embodiment.

FIG. 18A illustrates an example of a photoelectric conversion system related to an on-vehicle camera. The photoelectric conversion system 300 includes an imaging device 310. The imaging device 310 is the photoelectric conversion device 100 according to any one of the first to seventh embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are an example of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), an application specific integrated circuit (ASIC), or the like, or may be realized by a combination of these.

The photoelectric conversion system 300 is connected to a vehicle information acquisition device 320 and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 18B illustrates the photoelectric conversion system in the case of capturing an image in front of the vehicle (imaging range 350). The vehicle information acquisition device 320 sends instructions to the photoelectric conversion system 300 or the imaging device 310. With such a configuration, the accuracy of distance measurement may be further improved.

Although an example in which control is performed so as not to collide with another vehicle has been described above, the present embodiment is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other mobile objects (mobile devices), such as, for example, a ship, an aircraft, or an industrial robot. In addition, the present embodiment is not limited to the movable object and may be widely applied to equipment using object recognition, such as intelligent transport systems (ITS).

### TENTH EMBODIMENT

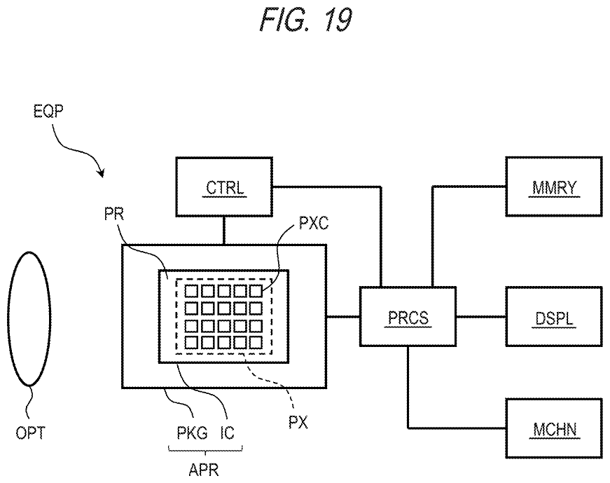

An equipment according to a tenth embodiment will be described with reference to FIG. 19. FIG. 19 is a block diagram illustrating a schematic configuration of an equipment according to the present embodiment.

FIG. 19 is a schematic diagram illustrating an equipment EQP including a photoelectric conversion device APR. The photoelectric conversion device APR has the function of the photoelectric conversion device 100 according to any of the first to seventh embodiments. All or part of the photoelectric conversion device APR is a semiconductor device IC. The photoelectric conversion device APR of the present example may be used as, for example, an image sensor, an auto focus (AF) sensor, a photometric sensor, or a distance measuring sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be arranged in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits on the second semiconductor chip may be column circuits corresponding to pixel columns of the first semiconductor chip. The peripheral circuits on the second semiconductor chip may be matrix circuits corresponding to pixels or pixel blocks on the first semiconductor chip. As the connection between the first semiconductor chip and the second semiconductor chip, a through electrode (through silicon via (TSV)), an inter-chip interconnection by direct bonding of a conductor such as copper, a connection by a micro bump between the chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR, and is, for example, a lens, a shutter, or a mirror. The control device CTRL controls the photoelectric conversion device APR and is, for example, a semiconductor device such as an ASIC. The processing device PRCS processes a signal output from the photoelectric conversion device APR and constitutes an analog front end (AFE) or a digital front end (DFE). The processing device PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 19 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an aircraft. The equipment EQP may be a medical device such as an endoscope or a computed tomography (CT) scanner.

The mechanical device MCHN in the transportation device may be used as a mobile device. The equipment EQP as a transportation device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a mobile device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### MODIFIED EMBODIMENTS

The present disclosure is not limited to the above embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

The circuit configurations of the pixels 12 illustrated in FIG. 3, FIG. 6, FIG. 12, and FIG. 15 are examples, and may be appropriately changed. For example, the number of photoelectric conversion units PD included in each pixel 12 is not limited to two, four or eight. Alternatively, a plurality of capacitance switching transistors M5 may be provided so that the capacitance value of the capacitor coupled to the node FD may be switched to a plurality of values.

The photoelectric conversion systems described in the eighth and ninth embodiments are examples of photoelectric conversion systems to which the photoelectric conversion device of the present disclosure may be applied, and the photoelectric conversion system to which the photoelectric conversion device of the present disclosure may be applied is not limited to the configurations illustrated in FIG. 17 and FIG. 18A.

According to the present disclosure, in a photoelectric conversion device including a plurality of photoelectric conversion element, it is possible to reduce the influence of noise generated due to driving of transistors configuring the pixel circuit.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068326, filed Apr. 17, 2025, which is hereby incorporated by reference herein in its entirety.

What is claimed is:

1. A photoelectric conversion device comprising:
a first photoelectric conversion unit and a second photoelectric conversion unit each configured to generate charge according to incidence of light;
a first transistor configured to transfer charge held by the first photoelectric conversion unit to a first node;
a second transistor configured to output a signal according to a voltage of the first node;
a third transistor configured to output an output signal of the second transistor to a first signal line; and
a fourth transistor configured to output the output signal of the second transistor to a second signal line,
wherein the first photoelectric conversion unit and the second photoelectric conversion unit are arranged in a first direction in a plan view,
wherein the second transistor is arranged to overlap a first straight line that passes between the first photoelectric conversion unit and the second photoelectric conversion unit and intersects the first direction in the plan view,
wherein the third transistor, the second transistor, and the fourth transistor are arranged in this order along the first direction,
wherein a gate electrode of the third transistor is arranged adjacent to the first photoelectric conversion unit in a second direction intersecting the first direction, and
wherein a gate electrode of the fourth transistor is arranged adjacent to the second photoelectric conversion unit in the second direction.

2. The photoelectric conversion device according to claim 1, further comprising:
a fifth transistor configured to reset a voltage of the first node,
wherein a gate electrode of the first transistor is arranged between the first photoelectric conversion unit and a gate electrode of the fifth transistor, and
wherein the gate electrode of the fifth transistor faces the gate electrode of the first transistor.

3. The photoelectric conversion device according to claim 2, further comprising:
a sixth transistor configured to transfer charge held by the second photoelectric conversion unit to the first node,
wherein a gate electrode of the sixth transistor is arranged between the second photoelectric conversion unit and the gate electrode of the fifth transistor, and
wherein the gate electrode of the fifth transistor faces the gate electrode of the sixth transistor.

4. The photoelectric conversion device according to claim 3,
wherein the gate electrode of the first transistor and the gate electrode of the sixth transistor are arranged line-symmetrically with respect to the first straight line as a symmetry axis in the plan view, and
the gate electrode of the fifth transistor is arranged to overlap the first straight line in the plan view.

5. The photoelectric conversion device according to claim 3, further comprising:
a seventh transistor configured to switch a capacitance value of a capacitor coupled to the first node,
wherein the gate electrode of the first transistor is arranged between the first photoelectric conversion unit and a gate electrode of the seventh transistor,
wherein the gate electrode of the sixth transistor is arranged between the second photoelectric conversion unit and the gate electrode of the seventh transistor, and
wherein the gate electrode of the seventh transistor faces the gate electrode of the first transistor and the gate electrode of the sixth transistor.

6. The photoelectric conversion device according to claim 5, wherein
the gate electrode of the first transistor and the gate electrode of the sixth transistor are arranged line-symmetrically with respect to the first straight line as a symmetry axis in the plan view, and
the gate electrode of the seventh transistor is arranged to overlap the first straight line in the plan view.

7. The photoelectric conversion device according to claim 3, wherein a gate electrode of the second transistor overlaps the first straight line and is arranged not to overlap a region between the gate electrode of the first transistor and the gate electrode of the sixth transistor in the plan view.

8. The photoelectric conversion device according to claim 3, further comprising:
a third photoelectric conversion unit and a fourth photoelectric conversion unit each configured to generate charge according to incidence of light;
an eighth transistor configured to transfer charge held by the third photoelectric conversion unit to the first node;
a ninth transistor configured to transfer charge held by the fourth photoelectric conversion unit to the first node;
a first microlens shared by the first photoelectric conversion unit and the third photoelectric conversion unit; and
a second microlens shared by the second photoelectric conversion unit and the fourth photoelectric conversion unit.

9. The photoelectric conversion device according to claim 8,
wherein the first photoelectric conversion unit and the first transistor, and the third photoelectric conversion unit and the eighth transistor are arranged line-symmetrically with respect to a second straight line extending in the first direction as a symmetry axis, and
wherein the second photoelectric conversion unit and the sixth transistor, and the fourth photoelectric conversion unit and the ninth transistor are arranged line-symmetrically with respect to the second straight line as a symmetry axis.

10. The photoelectric conversion device according to claim 5, further comprising:
a third photoelectric conversion unit and a fourth photoelectric conversion unit each configured to generate charge according to incidence of light;
an eighth transistor configured to transfer charge held by the third photoelectric conversion unit to the first node; and
a ninth transistor configured to transfer charge held by the fourth photoelectric conversion unit to the first node,
wherein the first photoelectric conversion unit, the second photoelectric conversion unit, the third photoelectric conversion unit, and the fourth photoelectric conversion unit are arranged in the first direction in the plan view,
wherein the second transistor, the third transistor, the fourth transistor, the fifth transistor, and the seventh transistor are arranged in the first direction in the plan view,
wherein a gate electrode of the fifth transistor is arranged adjacent to the third photoelectric conversion unit in the second direction, and
wherein a gate electrode of the seventh transistor is arranged adjacent to the fourth photoelectric conversion unit in the second direction.

11. The photoelectric conversion device according to claim 3, further comprising:
an insulator isolation portion configured to define a first active region provided with the first photoelectric conversion unit and the first transistor and a second active region provided with the second photoelectric conversion unit and the sixth transistor in a first face of a semiconductor layer.

12. The photoelectric conversion device according to claim 11, wherein the first active region and the second active region are independent of each other.

13. The photoelectric conversion device according to claim 11, wherein the first active region and the second active region constitute one continuous active region.

14. The photoelectric conversion device according to claim 11, wherein the first photoelectric conversion unit and the second photoelectric conversion unit are configured to receive light from a side of the first face.

15. The photoelectric conversion device according to claim 11, wherein the first photoelectric conversion unit and the second photoelectric conversion unit are configured to receive light from a side of a second face of the semiconductor layer opposite to the first face.

16. The photoelectric conversion device according to claim 1, wherein the second transistor, the third transistor, and the fourth transistor are arranged in different active regions.

17. The photoelectric conversion device according to claim 1, wherein the second transistor, the third transistor, and the fourth transistor are arranged in the same active region.

18. The photoelectric conversion device according to claim 1, further comprising:
a sixth transistor configured to transfer charge held by the second photoelectric conversion unit to a second node,
wherein the first photoelectric conversion unit and the first transistor, and the second photoelectric conversion unit and the sixth transistor are arranged in translational symmetry with respect to the first direction in the plan view.

19. A photoelectric conversion device comprising:
an insulator isolation portion configured to define a plurality of active regions in a first face of a semiconductor layer;
a first photoelectric conversion unit arranged in a first active region of the plurality of active regions and configured to generate charge according to incidence of light;
a second photoelectric conversion unit arranged in a second active region of the plurality of active regions and configured to generate charge according to incidence of light;
a first transistor arranged in the first active region and configured to transfer charge of the first photoelectric conversion unit to a first node;
a second transistor arranged in a third active region and configured to output a signal according to a voltage of the first node;
a third transistor arranged in a fourth active region and configured to output an output signal of the second transistor to a first signal line; and
a fourth transistor arranged in a fifth active region and configured to output the output signal of the second transistor to a second signal line,
wherein the first photoelectric conversion unit and the second photoelectric conversion unit are arranged in a first direction in a plan view,
wherein the second transistor is arranged to overlap a first straight line that passes between the first photoelectric conversion unit and the second photoelectric conversion unit and intersects the first direction in the plan view,
wherein the third transistor, the second transistor, and the fourth transistor are arranged in this order along the first direction,
wherein a gate electrode of the third transistor is arranged adjacent to the first photoelectric conversion unit in a second direction intersecting the first direction, and
wherein a gate electrode of the fourth transistor is arranged adjacent to the second photoelectric conversion unit in the second direction.

20. A photoelectric conversion system comprising:
the photoelectric conversion device according to claim 1; and
a signal processing device configured to process a signal output from the photoelectric conversion device.

21. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

22. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.
